(19) United States
(12) Patent Application Publication
(10) Pub. No.: US 2025/0192879 A1
(43) Pub. Date: Jun. 12, 2025

(54) GROUP-BASED ACCESS OF PASSIVE RFID TAGS

(71) Applicant: QUALCOMM Incorporated, San Diego, CA (US)

(72) Inventors: Luanxia YANG, Beijing (CN); Piyush GUPTA, Bridgewater, NJ (US); Xiaojie WANG, Hillsborough, NJ (US); Junyi LI, Greentown, PA (US)

(21) Appl. No.: 18/871,140

(22) PCT Filed: Jul. 20, 2022
(86) PCT No.: PCT/CN2022/106658

§ 371 Date: Dec. 2, 2024

(51) Int. Cl. H04B 7/22; G06K 7/10; H04L 5/00

(52) U.S. Cl. CPC H04B 7/22; G06K 7/10019; H04L 5/0005

(57) ABSTRACT

Certain aspects of the present disclosure provide techniques for radio frequency identification (RFID) tag singulation. Certain aspects provide a method for wireless communication by a first receiver, such as a passive RFID tag. The method generally includes receiving, from a transmitter, a first signal initiating a first inventory round and in response to receiving the first signal, backscattering a second signal to the transmitter, wherein the second signal is backscattered using resources specific to the first receiver.

### BACKGROUND

### Field of the Disclosure

Aspects of the present disclosure relate to wireless communications, and more particularly, to techniques for group-based access of passive radio frequency identification (RFID) tags.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method of wireless communication by a first receiver. The method includes receiving, from a transmitter, a first signal initiating a first inventory round; and in response to receiving the first signal, backscattering a second signal to the transmitter, wherein the second signal is backscattered using resources specific to the first receiver.

Another aspect provides a method of wireless communication by a transmitter. The method includes transmitting, to at least a first receiver, a first signal initiating a first inventory round; and in response to transmitting the first signal, receiving a second signal from at least the first receiver, wherein the second signal is backscattered to the transmitter, by the first receiver, using resources specific to the first receiver.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 illustrates a radio frequency identification (RFID) system.

FIG. 6 is a call flow diagram illustrating example signaling between a reader and a passive RFID tag performing an example inventory procedure.

FIG. 7 is a call flow diagram illustrating example signaling between a reader and a passive RFID tag performing an example inventory procedure using resources specific to the passive RFID tag.

FIG. 8 illustrates an example table of backscatter link frequency (BLF) values and tolerances.

FIG. 9 illustrates example backscattering of data at different frequencies.

FIG. 10 illustrates example backscattering for a frequency division multiplexed (FDMed) transmission of multiple signals over multiple contiguous subcarriers.

FIG. 11 illustrates example backscattering for FDMed transmission of multiple signals over multiple non-contiguous subcarriers.

FIG. 12 illustrates example backscattering using resources of different time-frequency patterns.

FIG. 13 illustrates example backscattering using resources at different symbols selected from a single resource pool.

FIG. 14 illustrates example backscattering 1400 using resources at different symbols selected from different resource pools.

FIG. 15 depicts a method for wireless communications.

FIG. 16 depicts a method for wireless communications.

FIG. 17 depicts aspects of an example communications device.

FIG. 18 depicts aspects of an example communications device.

### DETAILED DESCRIPTION

Aspects of the present disclosure provide apparatuses, methods, processing systems, and computer-readable mediums for group-based access of radio frequency identification (RFID) tags, and more specifically, passive RFID tags.

A new generation of wireless devices may overcome conventional limitations of on-board energy storage by harvesting energy from wireless signals (e.g., radio frequency (RF) signals) to perform wireless communications. Such energy harvesting devices (e.g., user equipments) may include, for example, RFID devices (e.g., RFID tags), that are capable of receiving signals and “backscattering” them to another device to perform wireless communications. These aforementioned devices may generally be passive, in which case they include no on-board energy storage and rely entirely on harvested energy from received signals to perform wireless communications (e.g., via backscattering signals). Thus, energy harvesting devices are a type of user equipment that provides low-cost and low-power solutions for many applications in a wireless communications system.

Singulation is a process by which a unique RFID tag (e.g., passive RFID tag) is isolated (e.g., distinguished) from a population of RFID tags. In particular, a reader (e.g., such as a network entity) may manage RFID tag populations using three operations: (1) selection, (2) inventory, and (3) access. Selection generally refers to a procedure by which the reader selects an RFID tag population for inventory and access. Inventory generally refers to a procedure by which the reader identifies an RFID tag from within the population. Further, access generally refers to a procedure by which the reader transacts with (that is, reads from or writes to) an individual tag, that is uniquely identified prior to access (via the inventory procedure). Operations such as selection, inventory, and access may be used for tag singulation.

The reader may begin an inventory procedure with passive RFID tags by broadcasting a Query command. The broadcasted Query command may include a value for a slot counter parameter, Q. Upon receiving the Query command, each passive RFID tag may initialize its slot counter by randomly selecting a number in the range of [0, 2^{Q}−1]. A passive RFID tag which initializes its slot counter to a target value, such as zero, may reply (e.g., via backscatter communication) to the Query command broadcasted by the reader. Although aspects herein use a target value of zero, other target values may be considered.

In some cases, however, when the reader broadcasts a Query command, no passive RFID tag slot counter may reach zero. As such, no RFID tag may backscatter a signal to the reader. Accordingly, the reader may transmit another command.

In some cases, the command transmitted prompts each of the passive RFID tags to adjust the value of the slot counter parameter, Q, based on the command. The command may be referred to as a “Query Adjust” command. Accordingly, each of the passive RFID tags may adjust the value of Q and randomly select a number in the range of [0, 2^{Q}−1] (e.g., where Q is the newly adjusted Q) as their corresponding slot counter value.

In some other cases, the command transmitted prompts each of the passive RFID tags to decrement their slot counter value (e.g., random number) by one. Each passive RFID tag decrements its slot counter by one whenever receiving the command. The command may be referred to as a “QueryRep” command.

In either of the cases described above, if a passive RFID tag's slot counter reaches zero, that passive RFID tag backscatters a signal to the reader. This procedure continues until at least one passive RFID tag selects a value for their slot counter equal to the target value, and thus, transmits a signal to the reader (e.g., via backscatter communication).

In some cases, multiple iterations of the above procedure may occur prior to a passive RFID tag selecting a value of their slot counter equal to the target value, thereby resulting in increased signaling overhead and/or decreased resource availability. Accordingly, in some cases, different approaches to reduce an amount of resources consumed and/or signaling overhead during the inventory procedure may be used. Example approaches for increasing the probability of a passive RFID tag's slot counter reaching a target value and benefits of increasing the probability (e.g., reducing resources consumed and/or signaling overhead) are described in more detail in commonly owned International Patent Application No. PCT/CN2022/106629, (Attorney Docket No. 2202086WO1), entitled “Tag Singulation of Passive RFID Tags,” filed on the same day, the entire content of which is incorporated herein by reference.

The aforementioned inventory procedure may be performed such that a reader is able to uniquely identify an individual passive RFID tag that the reader transacts with (e.g., accesses), or in other words, reads from or writes to. However, in some cases, a reader may desire to identify and access more than one passive RFID tag at one time. For example, identifying (e.g., during the inventory procedure) and accessing more than one passive RFID tag at a single time may allow the communications system (e.g., between the reader and passive RFID tags) to operate more efficiently and save transmission power, thereby increasing system capacity (e.g., the number of users the system can reliably support at any given time).

Accordingly, aspects of the present disclosure provide different approaches to enable accessing of multiple passive RFID tags by a reader. The different approaches described herein may involve different passive RFID tags backscattering signals to the reader using resources specific to each passive RFID tag. For example, in certain aspects, in response to receiving a signal from the reader initiating the inventory procedure, different passive RFID tags may backscatter data to the reader at different frequencies. In certain aspects, in response to receiving a signal from the reader initiating the inventory procedure, different passive RFID tags may backscatter data to the reader using different orthogonal cover codes (OCCs). In certain aspects, in response to receiving a signal from the reader initiating the inventory procedure, different passive RFID tags may backscatter data to the reader using different time-frequency patterns. In some cases, backscattering the data to the reader may include backscattering repetitions of the data using resources of a time-frequency pattern corresponding to each passive RFID tag. Accordingly, using one or more of the approaches described above, a reader may be able to access more than one RFID tag at a single time.

In some cases, the techniques described herein which are used to enable the accessing of multiple passive RFID tags by a reader may result in collision(s) of backscattered data, by two or more passive RFID tags. In such cases, the reader may not be able to resolve (may not be able to distinguish/differentiate which data/signal is from which passive RFID tag). Accordingly, in certain aspects to help avoid collisions, prior to backscattering data to the reader, a slot counter for each of the multiple passive RFID tags may need to be equal to a target value (e.g., zero). Where a slot counter for a passive RFID tag is not equal to the target value, the passive RFID tag may not backscatter a signal to the reader using resources specific to the passive RFID tag. Instead, only passive RFID tags having a slot counter equal to zero may backscatter a signal to the reader using resources specific to each of the passive RFID tags.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

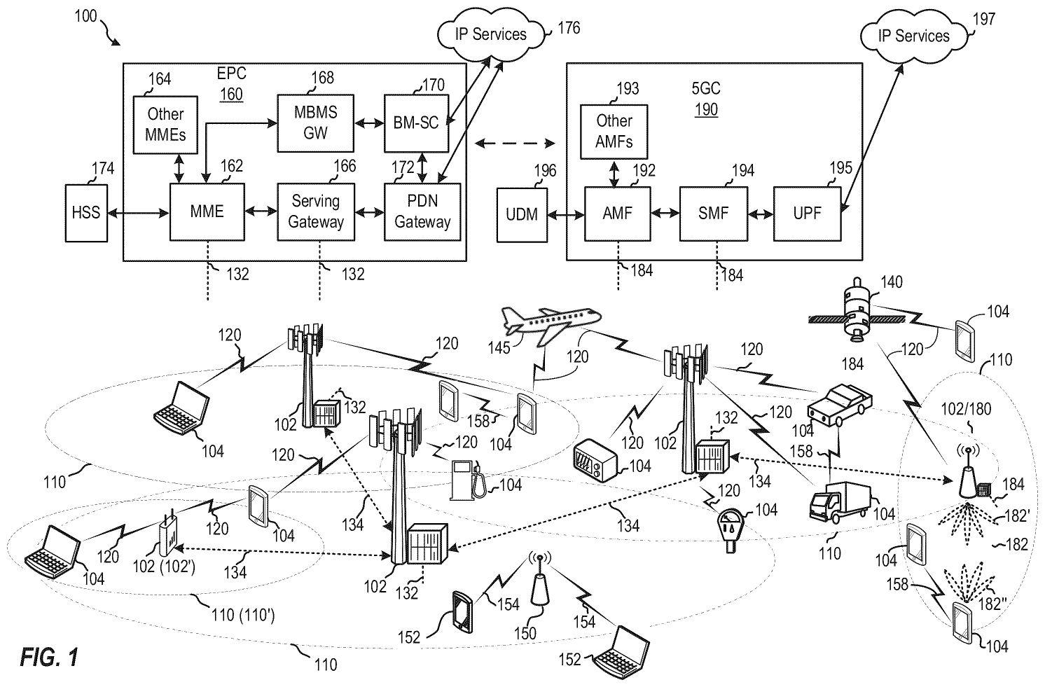

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (CNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

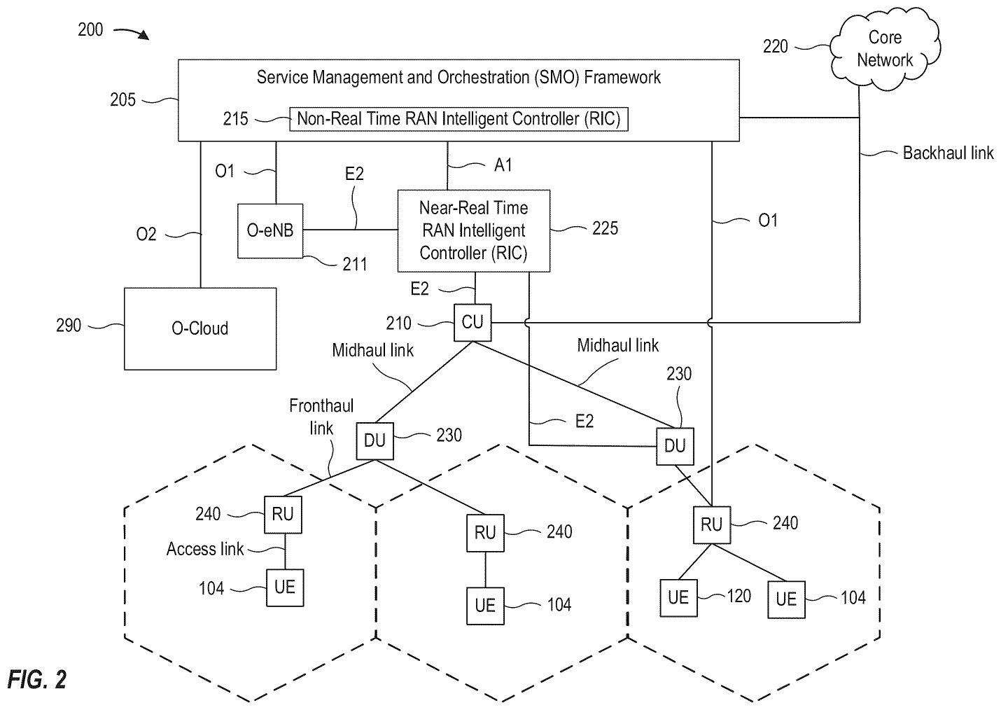

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHZ-7125 MHz, which is often referred to (interchangeably) as “Sub-6 GHz”. Similarly, 3GPP currently defines Frequency Range 2 (FR2) as including 24,250 MHz-52,600 MHZ, which is sometimes referred to (interchangeably) as a “millimeter wave” (“mmW” or “mm Wave”). A base station configured to communicate using mmWave/near mm Wave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

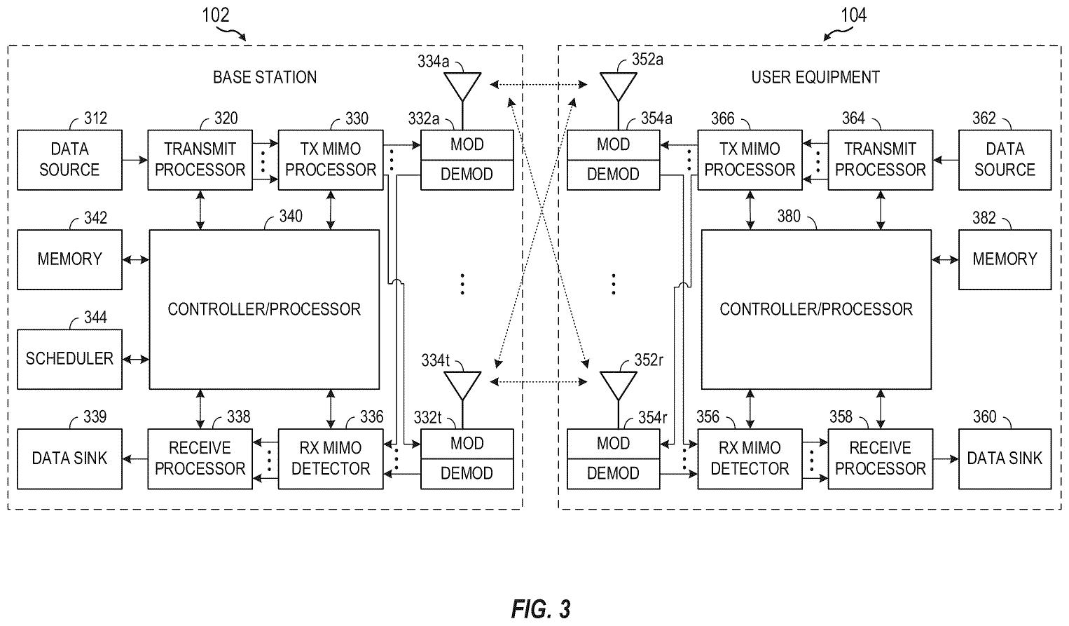

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

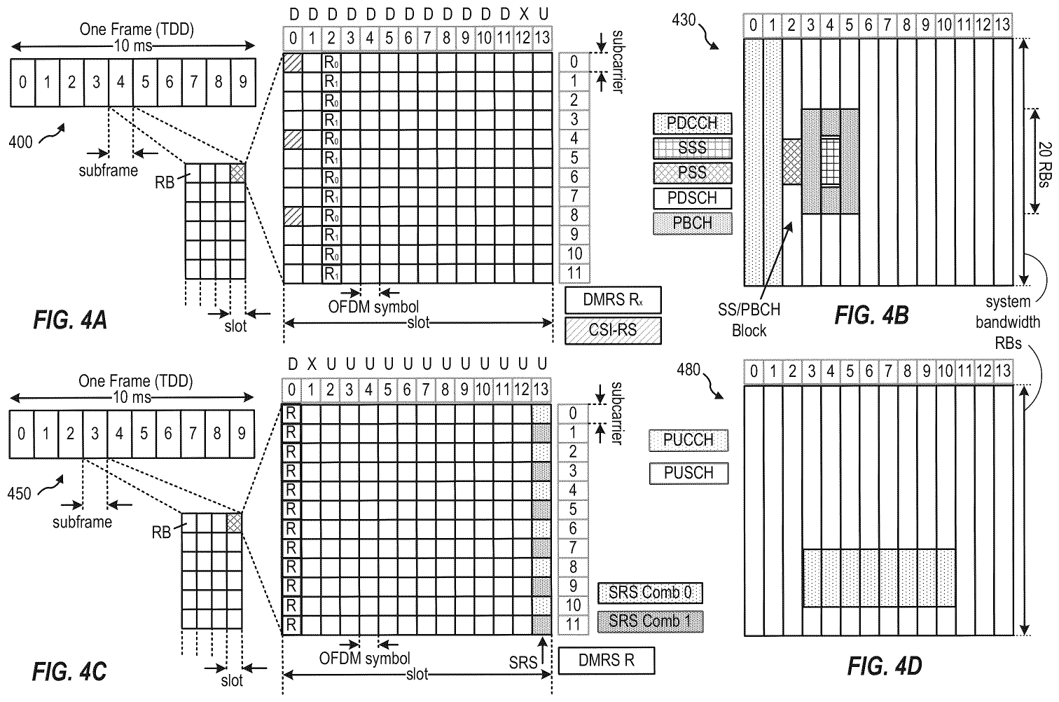

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Introduction to Energy Harvesting in RFID Systems

Radio frequency identification (RFID) is a rapidly growing technology impacting many industries due to its economic potential for inventory/asset management within warehouses, internet of things (IoT), sustainable sensor networks in factories and/or agriculture, and smart homes, to name a few example applications. RFID technology consists of RFID devices (or backscatter devices), such as transponders, or tags, that emit an information-bearing signal upon receiving an energizing signal.

In certain aspects, RFID devices may be operated without a battery. Generally, RFID devices that are operated without a battery are known as passive RFID devices. Passive RFID devices may operate by harvesting energy from received radio frequency signals (e.g., “over the air”), thereby powering reception and transmission circuitry within the RFID devices. This harvested energy allows passive RFID devices to transmit information, sometimes referred to as backscatter modulated information, without the need for a local power source within the RFID device. On the other hand, in certain aspects, RFID device may be semi-passive and include on-board energy storage to supplement their ability to harvest energy from received signals (however, at higher cost).

In certain aspects, in addition to harvesting power from RF sources, energy harvesting devices may accumulate energy from other direct energy sources, such as solar energy, in order to supplement its power demands. Semi-passive energy harvesting devices may in some cases include power consuming RF components, such as analog to digital converters (ADCs), mixers, and oscillators.

Thus, RFID devices are a type of user equipment that provides a low-cost and low-power solutions for many applications in a wireless communications system. Such devices may be very power efficient, sometimes requiring less than 0.1 mW of power to operate. Further, their relatively simple architectures and, in some cases, lack of battery, mean that such devices can be small, lightweight, and easily installed or integrated in many types of environments or host devices. Generally speaking then, RFID devices provide practical and necessary solutions to many networking applications that require, low-cost, small footprint, durable, maintenance-free, and long lifespan communications devices. For example, RFID devices may be configured as long endurance industrial sensors, which mitigates the problems of replacing batteries in and around dangerous machinery.

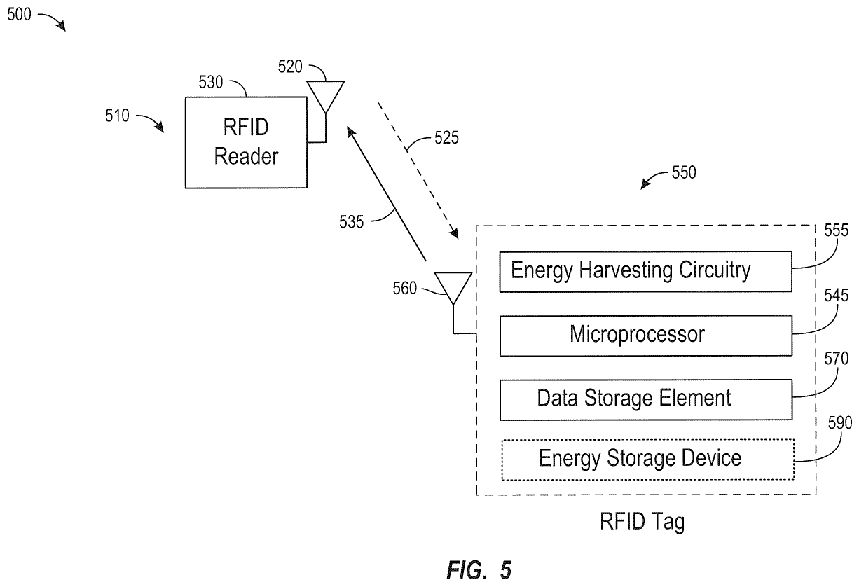

FIG. 5 shows an RFID system 500. As shown, RFID system 500 includes a reader 510 and an RFID tag 550. Reader 510 may also be referred to as an interrogator or a scanner. RFID tag 550 may also be referred to as an interrogator, RFID label, or an electronics label. In certain aspects, reader 510 is a network entity (e.g., such as a gNB) and RFID tag 550 is a user equipment (UE).

Reader 510 includes an antenna 520 and an electronics unit 530. Antenna 520 radiates signals transmitted by reader 510 and receives signals from RFID tags and/or other devices. Electronics unit 530 may include a transmitter and a receiver for reading RFID tags such as RFID tag 550. The same pair of transmitter and receiver (or another pair of transmitter and receiver) may support bi-directional communication with wireless networks, wireless devices, etc. Electronics unit 530 may include processing circuitry (e.g., a processor) to perform processing for data being transmitted and received by the RFID reader 510.

As shown, RFID tag 550 includes an antenna 560 and a data storage element 570. Antenna 560 radiates signals transmitted by RFID tag 550 and receives signals from RFID reader 510 and/or other devices. Data storage element 570 stores information for RFID tag 550, for example, in an electrically erasable programmable read-only memory (EEPROM) or another type of memory. RFID tag 550 may also include an electronics unit that can process the received signal and generate the signals to be transmitted.

In certain aspects, RFID tag 550 may be a passive RFID tag having no battery. In this case, induction may be used to power the RFID tag 550. For example, in some cases, a magnetic field from a signal transmitted by reader 510 may induce an electrical current in RFID tag 550, which may then operate based on the induced current. RFID tag 550 can radiate its signal in response to receiving a signal from RFID reader 510 or some other device. In certain other aspects, RFID tag 550 may optionally include an energy storage device 590, such as a battery, capacitor, etc., for storing energy harvested using energy harvesting circuitry 555, as described below.

In one example, RFID tag 550 may be read by placing the reader 510 within close proximity to RFID tag 550. Reader 510 may radiate a first signal 525 via the antenna 520. In some cases, the first signal 525 may be known as an interrogation signal or energy signal. In some cases, energy of the first signal 525 may be coupled from reader antenna 520 to RFID tag antenna 560 via magnetic coupling and/or other phenomena. In other words, the RFID tag 550 may receive the first signal 525 from reader 510 via antenna 560 and energy of the first signal 525 may be harvested using energy harvesting circuitry 555 (e.g., an RF transducer) and used to power RFID tag 550. For example, energy of the first signal 525 received by RFID tag 550 may be used to power a microprocessor 545 of RFID tag 550. Microprocessor 545 may, in turn, retrieve information stored in a data storage element 570 of RFID tag 550 and transmit the retrieved information via a second signal 535 using the antenna 560. For example, in some cases, microprocessor 545 may generate the second signal 535 by modulating a baseband signal (e.g., generated using energy of the first signal 525) with the information retrieved from the data storage element 570. In some cases, this second signal 535 may be known as a backscatter modulated information signal. Thereafter, as noted, microprocessor 545 transmits the second signal 535 to reader 510. Reader 510 may receive the second signal 535 from RFID tag 550 via antenna 520 and may process (e.g., demodulate) the received signal to obtain the information of data storage element 570 sent in second signal 535.

In some cases, RFID system 500 may be designed to operate at 13.56 MHz or some other frequency (e.g., an ultra-high frequency (UHF) band at 900 MHZ). Reader 510 may have a specified maximum transmit power level, which may be imposed by the Federal Communication Commission (FCC) in the United Stated or other regulatory bodies in other countries. The specified maximum transmit power level of reader 510 may limit the distance at which RFID tag 550 can be read by reader 510.

Wireless technology is increasingly useful in industrial applications, such as ultra-reliable low-latency communication (URLLC) and machine type communication (MTC). In such domains, and others, it is desirable to support devices (e.g., passive RFID tags) that are capable of harvesting energy from wireless energy sources (e.g., in lieu of or in combination with a battery or other energy storage device, such as a capacitor), such as RF signals, thermal energy, solar energy, and the like.

### Aspects Related to Group-Based Access of Passive RFID Tags

Aspects of the present disclosure provide techniques for group-based access of radio frequency identification (RFID) tags, and more specifically, passive RFID tags. As noted above, a reader may manage RFID tag populations using three operations: (1) selection, (2) inventory, and (3) access. Selection generally refers to a procedure by which the reader selects an RFID tag population for inventory and access. Inventory generally refers to a procedure by which the reader identifies one or more RFID tags. Further, access generally refers to a procedure by which the reader transacts with (that is, reads from or writes to) an individual tags, that is uniquely identified prior to access. Operations such as select, inventory, and access may be used for tag singulation. Singulation is a process by which a unique RFID tag is isolated from a population of RFID tags.

With respect to the inventory procedure, a sequence of commands may be sent and received between both a reader and an RFID tag to allow the reader to identify an identifier code of the RFID tag, such as an electronic product code (EPC) of the RFID tag. For example, the reader may begin an inventory procedure by broadcasting a Query command. The broadcasted Query command may include a value for a slot counter parameter, Q, where the value for the slot counter parameter is between zero and fifteen. Upon receiving the Query command, each RFID tag may initialize its slot counter by randomly selecting a number in the range of [0, 2^{Q}−1]. An RFID tag which initializes its slot counter to a target value (e.g., a target value of zero, for example, randomly selects 0 from [0, 2^{Q}−1]) may reply to the Query command broadcasted by the reader.

In cases where the RFID tag is a passive device, the RFID tag may reply via backscatter communication. Backscatter is method which uses an incident radio frequency RF signal to transmit data without a battery or power source. For example, RFID tag may harvest energy from the Query command (e.g., energy signal) using EH circuitry (such as energy harvesting circuitry 555 illustrated in FIG. 5). The RFID tag may use this harvested energy to (1) power one or more other components of the second device and (2) reflect a signal back to the first device. This type of communication may be known as backscatter communication

In the reply signal to the reader, the RFID may send a 16-bit random number to the reader. At the same time, this RFID tag may transition to a Reply state, while the other RFID tags transition to an Arbitrate state. Where the response from the RFID tag is successfully receiver, the RFID reader may reply by sending an acknowledgement (ACK) command, together with the same 16-bit random number. This response may then allow the RFID tag to send back its tag ID and/or EPC to the reader.

In some cases, however, when the reader broadcasts the Query command, no RFID tag which receives the signal may select a value of the slot counter equal be zero. As such, no RFID tag may backscatter a signal to the reader. Traditionally, after a (pre)defined period of time has passed without receiving a response from an RFID tag, the reader may transmit a command.

In some cases, the command transmitted prompts each of the passive RFID tags to adjust the value of the slot counter parameter, Q, based on the command. The command may be referred to as a “Query Adjust” command. Accordingly, each of the passive RFID tags adjust the value of Q and randomly select a number in the range of [0, 2^{Q}−1] (e.g., where Q is the newly adjusted Q) as their corresponding slot counter value when receiving the command.

In some other cases, the command asks each of the RFID tags to decrement their slot counter value (e.g., random number) by one. Accordingly, each passive RFID tag decrements its slot counter by one whenever receiving the command. The command may be referred to as a “QueryRep” command.

This procedure continues until an RFID tag selects a value for their slot counter equal to zero, and thus, transmits a signal to the reader (e.g., via backscatter communication where the RFID tag is a passive RFID device). In some cases, multiple iterations of the above procedure may occur prior to an RFID tag selecting a value of their slot counter equal to zero. In some cases, the procedure may involve the use of both “Query Adjust” and “QueryRep” commands until an RFID tag selects a value for their slot counter equal to zero.

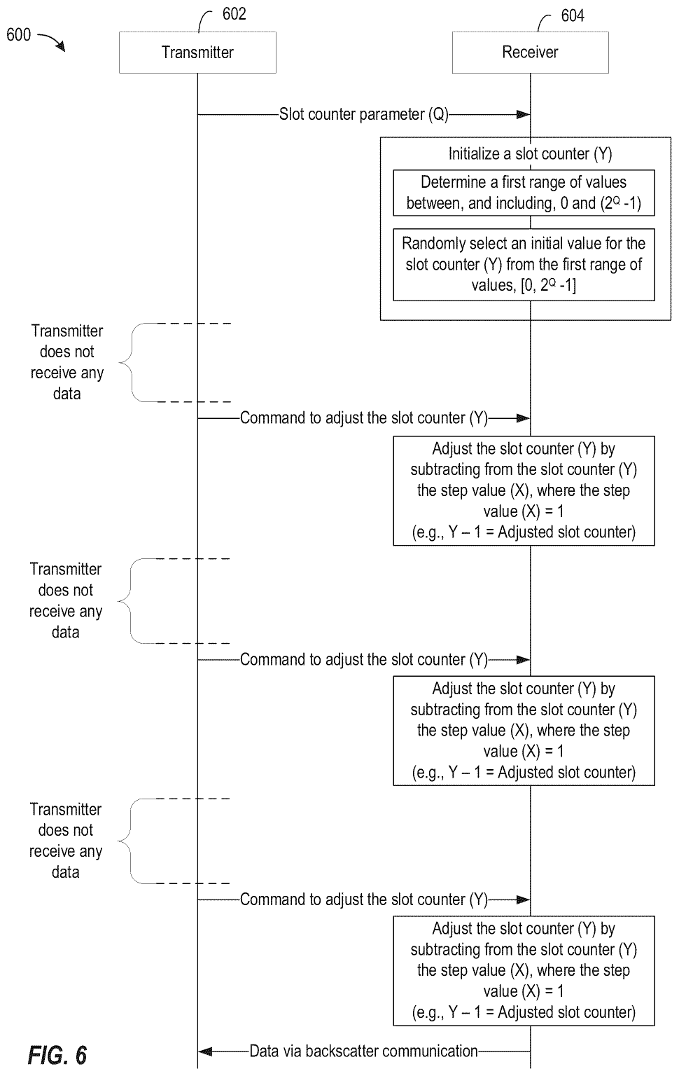

An example procedure, as described above, is illustrated in FIG. 6. In particular, FIG. 6 is a call flow diagram illustrating example signaling 600 between a transmitter 602 and a receiver 604 performing an example inventory procedure. In certain aspects, transmitter 602 is a reader, such as RFID reader 510 illustrated in FIG. 5, and receiver 604 is a passive RFID tag, such as RFID tag 550 (where RFID tag 550 is a passive RFID device) illustrated in FIG. 5. However, in other aspects, transmitter 602 may be another type of wireless communications device (e.g., network entity, network node, etc.), and, similarly, receiver 604 may be another type of wireless communications device (e.g., UE, etc.), such as those described herein. In the example inventory procedure of FIG. 6, three iterations of the above procedure may be performed until a slot counter value of the passive RFID tag equals a target value (e.g., zero), and thus, may transmit a signal, back to the reader, via backscatter communication.

Though the example inventory procedure illustrated in FIG. 6 illustrates only the use of “QueryRep” commands (e.g., commands prompting each of the passive RFID tags to decrement their slot counter value), in certain embodiments, “QueryAdjust” commands (e.g., commands prompting each of the passive RFID tags to adjust the value of Q and select a new random number in the range of [0, 2^{Q}−1] (e.g., where Q is the newly adjusted Q) as their corresponding slot counter value) may be used as an alternative to the illustrated “QueryRep” commands or in addition to the illustrated “QueryRep” commands.

As shown, the inventory procedure begins by transmitter 602 transmitting a value of a slot counter parameter, Q, via broadcast communication. As mentioned, in certain aspects, the value for the slot counter parameter, Q, is between zero and fifteen. One or more receivers 604 (although shown as only one receiver 604 in FIG. 6) may receive the broadcasted slot counter parameter value, and in response, initialize a slot counter value, Y. In certain aspects, initializing a slot counter value, Y, includes (1) determining a first range of values between, and including zero and 2^{Q}−1 and (2) randomly selecting an initial value for the slot counter, Y, from the first range of values, [0, 2^{Q}−1]. For example, where Q=4, receiver 604 may randomly select an initial value for the slot counter between, and including, [0, 2⁴−1], or [0, 15]. In this example, receiver 604 may randomly select the initial value for the slot counter to be equal to three (e.g., Y=3).

In this example, receiver 604 may select an initial value for the slot counter, Y, not equal to a target value of zero. As such, receiver 604 does not backscatter a signal to transmitter 602. Further, in this example, other receivers which receive the broadcasted parameter, Q, also select an initial value for the slot counter, Y, not equal to the target value of zero. Accordingly, no receiver, including receiver 604, backscatters a signal to transmitter 602.

Transmitter 602 may wait for a response from a receiver for a (pre)defined amount of time. Where a response is not received from a receiver in a window having the (pre)defined amount of time, transmitter 602 may subsequently transmit a command (e.g., a “QueryRep” command) to adjust a value of the slot counter, Y, by a step value equal to one. More specifically, the command may ask each receiver, including receiver 604, to decrement a value of their slot counter, Y, by one (e.g., Adjusted slot counter, Y_{adjusted}=Y−1). For example, where the previously selected slot counter value equals three, the adjusted slot counter value is equal to two (e.g., Y_{adjusted}=3−1=2).

Again, a value of the slot counter is not equal to zero (e.g., 2≠0), and receiver 604 does not backscatter a signal to transmitter 602. Other receivers, after decrementing a value of their slot counter may also not have a slot counter value equal to zero. Accordingly, transmitter 602 may not receive a response from a receiver in a window having the (pre)defined amount of time.

This process may repeat two more times until a value of the slot counter parameter for receiver 604 is equal to zero. Receiver 604 transmits, to transmitter 602, data via backscatter communication when the slot counter value is equal to zero. This example assumes that for three iterations, no other receiver beyond receiver 604, has a slot counter value equal to zero.

As illustrated, the example inventory procedure illustrated in FIG. 6 may enable transmitter 602 to uniquely identify receiver 604, from a population of receivers, to be able to transact with (e.g., access, or in other words, read from or write to) receiver 604.

Although not illustrated, in some cases, more than one receiver may have a slot counter value equal to zero (e.g., after initialization of the slot counter value or after adjusting the slot counter value); thus, more than one receiver may transmit data to the reader via backscatter communication (e.g., receiver 604 in FIG. 6 and at least one other receiver may backscatter data to transmitter 602). Backscattered data from more than one receiver may result in a collision, which the reader may not be able to resolve (may not be able to distinguish/differentiate which data/signal is from which receiver). This may confuse the reader. Accordingly, different interface protocol standards (and different systems) use different techniques to resolve such collisions to cause each receiver to respond to transmitter 602 at different techniques, in other words, different techniques are used to “singulate” (e.g., distinguish/differentiate and access) the receivers.

In some cases, however, transmitter 602 (e.g., reader) may desire to identify and access more than one receiver (e.g., more than one passive RFID tag) at one time. For example, identifying (e.g., during the inventory procedure) and accessing more than one receiver at a single time may allow the communications system (e.g., between transmitter 602 and receivers, including receiver 604) to operate more efficiently and save transmission power, thereby increasing system capacity.

Accordingly, aspects of the present disclosure provide different approaches to enable accessing of multiple passive RFID tags by a reader (e.g., group-based access of passive RFID tags by a reader). The different approaches described herein may involve different passive RFID tags backscattering signals to the reader using resources specific to each passive RFID tag to allow a reader to differentiate, and subsequently access, different passive RFID tags that backscatter signals simultaneously.

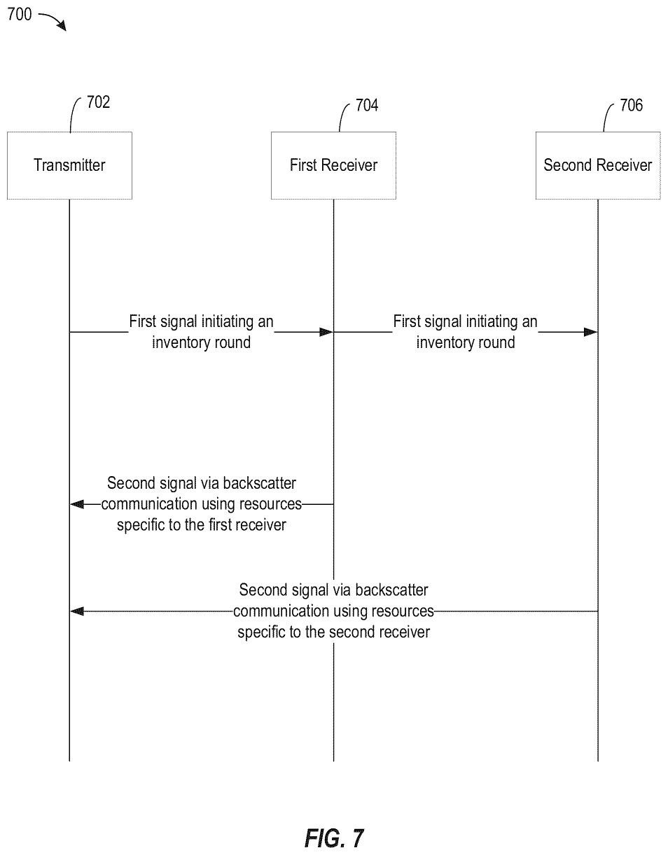

FIG. 7 is a call flow diagram illustrating example signaling 700 between a transmitter 702, a first receiver 704, and a second receiver 706 performing an example inventory procedure where first and second receivers 704, 706 use resources specific to each of the first and second receivers 704, 706 for backscattering. In certain aspects, transmitter 702 is a reader, such as RFID reader 510 illustrated in FIG. 5, first receiver 704 is a passive RFID tag, such as RFID tag 550 (where RFID tag 550 is a passive RFID device) illustrated in FIG. 5, and second receiver 706 is a passive RFID tag, such as RFID tag 550 (where RFID tag 550 is a passive RFID device) illustrated in FIG. 5. However, in other aspects, transmitter 702 may be another type of wireless communications device (e.g., network entity, network node, etc.), and, similarly, first receiver 704 and second receiver 706 may be another type of wireless communications device (e.g., UE, etc.), such as those described herein.

As shown in FIG. 7, the example inventory procedure begins by transmitter 702 transmitting a first signal initiating the inventory procedure (interchangeably referred to herein as an “inventory round”). In certain aspects, transmitter 702 transmits the first signal via broadcast communication. Although FIG. 7 illustrates first receiver 704 and second receiver 706 receiving the first signal from transmitter 702, in other examples, one or more other receivers may also receive the first signal.

In response to receiving the first signal, first receiver 704 and second receiver 706 backscatter a second signal to transmitter 702. To avoid a collisions of the second signal from each of first receiver 704 and second receiver 706 at transmitter 702, first receiver 704 backscatters the second signal to transmitter 702 using resources specific to first receiver 704 and second receiver 706 backscatters the second signal to transmitter 702 using resources specific to second receiver 706.

In certain aspects, the resources specific to first receiver 704 include a first orthogonal cover code (OCC) and the resources specific to second receiver 706 include a second OCC. The first OCC used by first receiver 704 to backscatter the second signal may be different than the second OCC used by second receiver 706 to backscatter the second signal. In other words, different receivers (e.g., passive RFID tags) may backscatter data to transmitter 702 using different OCCs.

In some cases, a plurality of OCCs are (pre)defined for the entire system. Accordingly, each receiver may select an OCC to use for backscattering data from the plurality of OCCs. The selection of an OCC may be random. For example, in FIG. 7, first receiver 704 may randomly select a first OCC from the plurality of OCCs (pre) defined for the system, and second receiver 706 may randomly select a second OCC from the plurality of OCCs (pre)defined for the system.

In some cases, a plurality of OCCs are (pre)defined for a group of receivers. For example, in FIG. 7, a plurality of OCCs may be (pre)defined for a group of receivers including first receiver 704 and second receiver 706. In other words, each receiver may be preconfigured with a plurality of OCCs (e.g., a set of OCCs). Each receiver may choose one OCC from the preconfigured set of OCCs. In some cases, each receiver may randomly select one OCC From the preconfigured set of OCCs.

In some cases, each receiver is preconfigured with a unique OCC. For example, in FIG. 7, first receiver 704 may be preconfigured with a first OCC and second receiver 706 may be preconfigured with a second OCC. Accordingly, when backscattering data to transmitter 702, first receiver 704 uses the first OCC and second receiver 706 uses the second OCC.

In certain other aspects, the resources specific to first receiver 704 include a first time-frequency resource and the resources specific to second receiver 706 include a second time-frequency resource. The first time-frequency resource used by first receiver 704 to backscatter the second signal may be different than the first time-frequency resource used by second receiver 706 to backscatter the second signal.

For example, in certain aspects, the first time-frequency resource used by first receiver 704 has a first frequency which is different than a second frequency of the second time-frequency resourced used by second receiver 704. In other words, different receivers (e.g., passive RFID tags) may backscatter data to a transmitter (e.g., the reader) at different frequencies. In particular, in response to receiving a signal from a transmitter initiating the inventory procedure, different receivers (e.g., two or more passive RFID tags) may transmit a signal back to the transmitter at different backscatter link frequencies (BLFs), wherein the BLF used by each receiver to signal back to the transmitter is specific to each receiver.

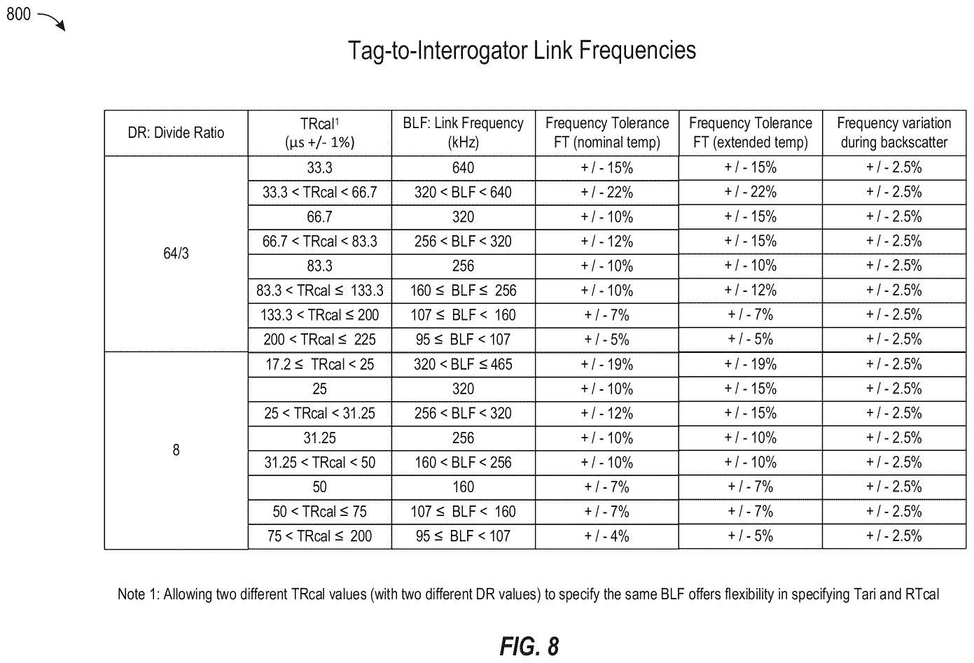

For example, each receiver may transmit a signal back to the transmitter (via backscatter communication) at a BLF calculated in accordance with Equation 1:

$$BLF = \frac{DR}{TRcal} + Δ {f}_{t} \qquad ( 1 )$$

where DR refers to a divide ratio, TRcal refers to tag-to-interrogator (e.g., RFID-to-reader or receiver-to-transmitter) calibration symbol, and Aft refers to a shift frequency specific to each receiver. For example, the transmitter shall specify a receiver's BLF (its FM0 data rate or the frequency of its Miller subcarrier) using the TRcal and DR in the preamble and payload. The receiver shall measure the length of TRcal, compute BLF, and adjust its T=>R link rate (e.g., tag-to-interrogator or RFID-to-reader link rate)) to be equal to the BLF. For example, FIG. 8 illustrates an example table 800 of BLF values (link frequencies) and tolerances.

A shift frequency, Δfₜ, specific to each receiver may be selected by each receiver (e.g., that is backscattering data to the transmitter) from a plurality of shift frequencies in a first resource pool. The plurality of shift frequencies in the first resource pool may be associated with the first signal transmitted (e.g., broadcasted) by the transmitter to the receivers. Each receiver may select a shift frequency, Δfₜ, from the first resource pool to backscatter data (e.g., in response to receiving the first signal from the transmitter) based on an identifier (ID) associated with each receiver. For example, different IDs associated with different receivers may map (e.g., hash) to different shift frequencies, Δfₜ. Such mapping techniques help avoid collisions in backscattering, for example, such as avoiding different receivers transmitting signals (e.g., via backscatter communication) using the same resources.

In certain aspects, the plurality of shift frequencies in the first resource pool (e.g., associated with the first signal transmitted by the transmitter) include all positive value shift frequencies or all negative value shift frequencies. This may occur where the first signal is a double band signal.

In certain aspects, the plurality of shift frequencies in the first resource pool (e.g., associated with the first signal transmitted by the transmitter) include both positive value shift frequencies and negative value shift frequencies. This may occur where the first signal is a single band signal.

In certain aspects, the plurality of shift frequencies in the first resource pool (e.g., associated with the first signal transmitted by the transmitter) include values based on a frequency of the first signal. For example, where the frequency of the first signal is equal to f₁, in some cases, the plurality of shift frequencies include

$$\{ \frac{{f}_{1}}{2} , \frac{{f}_{1}}{4} , \frac{{f}_{1}}{6} , \frac{{f}_{1}}{8} , … \} .$$

Other shift frequencies based on the frequency of the first signal may be considered, as well.

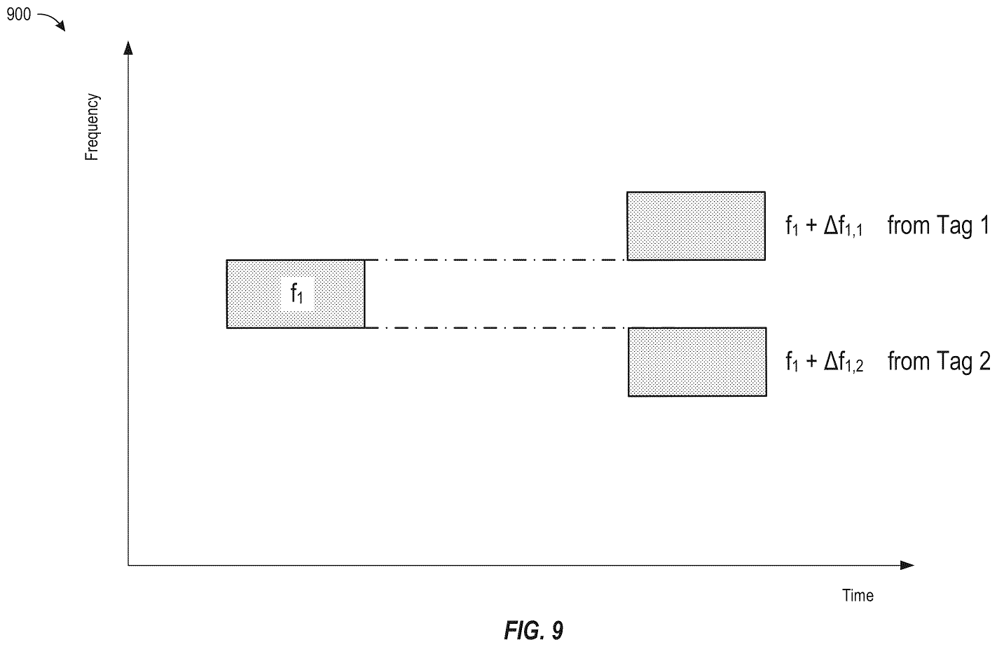

FIG. 9 illustrates example backscattering of data 900 at different frequencies. FIG. 9 illustrates an example inventory procedure between a reader, a first tag, Tag 1, and a second tag, Tag 2. Tag 1 and Tag 2 may each be a passive RFID tag, such as RFID tag 550 (where RFID tag 550 is a passive RFID device) illustrated in FIG. 5.

Similar to FIG. 7, the example inventory procedure illustrated in FIG. 9, begins by a reader transmitting a first signal initiating the inventory procedure. In certain aspects, the reader transmits the first signal via broadcast communication. Per the example inventory procedure illustrated in FIG. 9, the reader transmits the first signal at a frequency, f₁.

In response to receiving the first signal, Tag 1 and Tag 2 backscatter a second signal to the reader. To avoid a collision of the second signal from each of Tag 1 and Tag 2 at the reader, Tag 1 backscatters the second signal to the reader using resources specific to Tag 1, and Tag 2 backscatters the second signal to the reader using resources specific to Tag 2. More specifically, Tag 1 backscatters the second signal to the reader using a first time-frequency resource having a first frequency equal to the frequency of the first signal, f₁, shifted by a first shift frequency, Δf_{1,1} (e.g., f₁+Δf_{1,1}). Tag 1 may select the first shift frequency, Δf_{1,1}, from a plurality of shift frequencies associated with the first signal based on an ID of Tag 1. For example, Tag 1 may select the first shift frequency, Δf_{1,1}, from the plurality of shift frequencies (e.g., in a first resource pool) based on (Tag 1's ID) mod (the choices of Δfₜ).

Similarly, Tag 2 backscatters the second signal to the reader using a second time-frequency resource having a second frequency equal to the frequency of the first signal, f₁, shifted by a second shift frequency, Δf_{1,2} (e.g., f₁+Δf_{1,2}). Tag 2 may select the second shift frequency, Δf_{1,2}, from the plurality of shift frequencies associated with the first signal based on an ID of Tag 2. For example, Tag 2 may select the second shift frequency, Δf_{1,2}, from the plurality of shift frequencies (e.g., in the first resource pool) based on (Tag 2's ID) mod (the choices of Δfₜ).

As shown in FIG. 9, the first shift frequency, Δf_{1,1}, selected by Tag 1 may be a positive value (e.g., Δf_{1,1}=(+) value) such that the second signal is backscattered to the reader at a frequency greater than the frequency of the first signal (e.g., f₁+Δf_{1,1}>f₁). On the other hand, as shown in FIG. 9, the second shift frequency, Δf_{1,2}, selected by Tag 2 may be a negative value (e.g., Δf_{1,2}=(−) value) such that the second signal is backscattered to the reader at a frequency less than the frequency of the first signal (e.g., f₁+Δf_{1,2}<f₁). This may be the case where the first signal transmitted by the reader is a single band signal. In certain other cases (not illustrated), where the first signal transmitted by the reader is a double band signal, the shift frequencies selected by Tag 1 and Tag 2 may include only all positive values or all negative values, but not both.

In certain aspects, the reader transmits (e.g., broadcasts) multiple signals. The multiple signals may be frequency division multiplexed (FDMed) such that they are transmitted at a same time. For example, each signal may be assigned to a single subcarrier of the FDMed transmission (e.g., each signal may occupy one resource element (RE)).

In certain aspects, the multiple signals are FDMed over multiple contiguous subcarriers. For example, the reader may transmit two signals, where the first signal is assigned to a first subcarrier of the FDMed transmission, the second signal is assigned to a second subcarrier of the FDMed transmission, and a third signal is assigned to a third subcarrier of the FDMed transmission. The first, second, and third subcarriers may be contiguous. Accordingly, a passive RFID tag which receives the FDMed transmission may not be able to distinguish the different signals of the different subcarriers. As such, a passive RFID tag which receives the FDMed transmission may backscatter multiple signals (e.g., for the multiple signals received) to the reader.

In certain aspects, each of the multiple signals included in the FDMed transmission may indicate different BLF. In particular, the BLF specified for each of the multiple signals may be in accordance with Equation 2:

$$BLF = \frac{DR}{TRcal} + Δ {f}_{w} \qquad ( 2 )$$

where, Δf_{w} varies for each of the different signals. For example, the first signal may indicate Δf_{w}=0, the second signal may indicate Δf_{w}=200, and the third signal may indicate Δf_{w}=400. Thus, the calculated BLF may be different for each of the different signals.

In certain aspects, a passive RFID tag which receives the FDMed transmission (e.g., having multiple signals indicating different BLF), may not be able to distinguish the different signals of the transmission given the different signals are transmitted on contiguous subcarriers. As such, the RFID tag may not know which signal's indicated information to follow (e.g., indicated BLF to use) for backscattering data to the reader for each of the multiple signals.

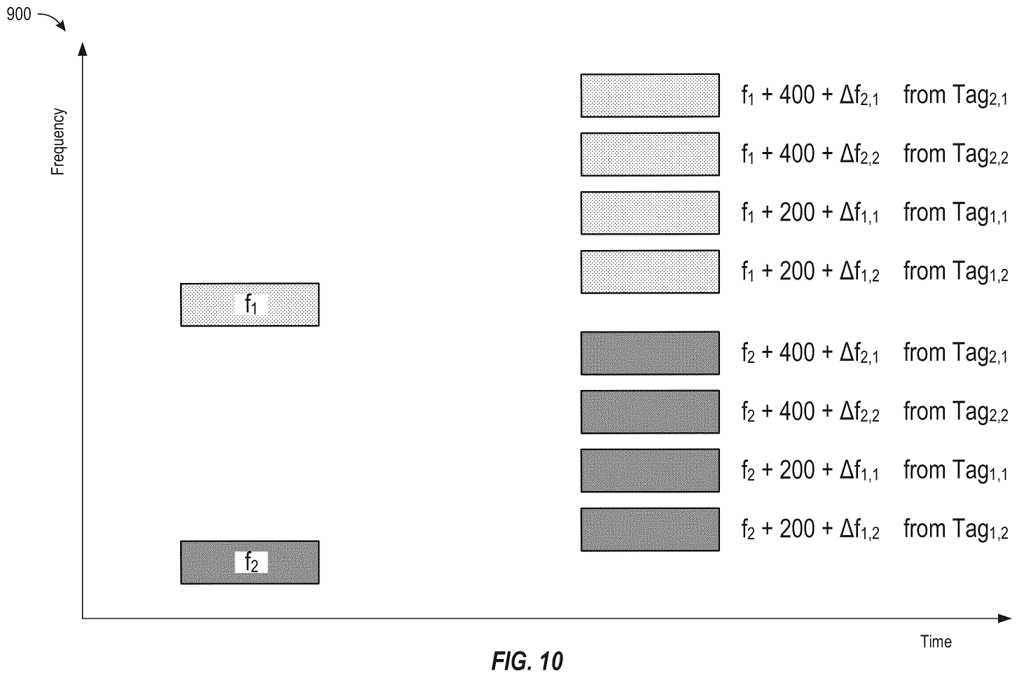

FIG. 10 illustrates example backscattering 1000 for an FDMed transmission of multiple signals over multiple contiguous subcarriers. For example, as shown in FIG. 10, a first signal at a frequency, f₁, and a second signal at a frequency, f₂, may be FDMed in a transmission. The first signal may be assigned to a first subcarrier of the FDMed transmission, and the second signal may be assigned to a second subcarrier of the FDMed transmission. The first and second subcarriers may be contiguous. The FDMed transmission may be transmitted (e.g., broadcast), from a reader, to a first tag, Tag 1, a second tag, Tag 2, a third tag, Tag 3, and a fourth tag, Tag 4 (e.g., where Tags 1-4 are passive RFID tags). Further, the first signal may indicate Δf_{w}=200, the second signal may indicate Δf_{w}=400.

In response to receiving the FDMed transmission, Tags 1-4 may backscatter signals to the reader. Tags 1-4 may not be able to distinguish the first signal and the second signal of the transmission given the different signals are transmitted on contiguous subcarriers. As such, the tags may not know which signal's indicated information to follow (e.g., indicated BLF to use) for backscattering data to the reader for each of the multiple signals. Accordingly, different options may be considered.

In a first option, the tags may choose to follow information (e.g., Δf_{w}, and in some cases a slot counter parameter, Q) indicated by either the first signal or the second signal in the FDMed transmission at random. For example, in some cases, Tag 1 may randomly choose to follow information (e.g., Δf_{w}=200) indicated by the first signal in the FDMed transmission. Accordingly, Tag 1 may backscatter signals to the reader at a frequency equal to (f₁+Δf_{w}=f₁+200) and/or (f₂+Δf_{w}=f₂+200). As another example, in some cases, Tag 1 may randomly choose to follow information (e.g., Δf_{w}=400) indicated by the second signal in the FDMed transmission. Accordingly, Tag 1 may backscatter signals to the reader at a frequency equal to (f₁+Δf_{w}=f₁+400) and/or (f₂+Δf_{w}=f₂+400).

In a second option, the tags may choose to follow information (e.g., Δf_{w}) indicated by either the first signal or the second signal in the FDMed transmission based on an ID associated with each of the tags. For example, Tag 1 may select the Δf_{w} indicated by the first signal or the second signal based on an ID associated with Tag 1. Similarly, Tag 2 may select the Δf_{w} indicated by the first signal or the second signal based on an ID associated with Tag 2. Tag 1 may choose to follow information (e.g., Δf_{w}) indicated by a signal in the FDMed transmission associated with mod (tag ID of Tag 1, the number of the signal) (e.g., Tag 1 may index the waveform with increased frequency).

In a third option, the first signal (e.g., at frequency, f₁) and the second signal (e.g., at frequency, f₂), each indicate a different value for a slot counter parameter, Q. As mentioned, the tags may use an indicated Q value to initialize their slot counters by randomly selecting a number in the range of [0, 2^{Q}−1]. The tags may choose to follow information (e.g., Δf_{w}) indicated by the first or second signal in the FDMed transmission based on selecting a rand number equal to a target value (e.g., zero) using either the Q value indicated by the first signal or the Q value indicated by the second signal.

In some cases, each tag may determine to use, for the random number selection, the value of the slot counter parameter, Q, indicated by the first signal or the second signal based on a type of data which is to be backscattered by each of tags. For example, the slot counter parameter, Q, may be divided into different ranges, where each range corresponds to one data type. Accordingly, a range of Q which corresponds to the data to be backscattered may be selected and used for the random number selection.

In some cases, each tag may determine to use, for the random number selection, the value of the slot counter parameter, Q, indicated by the first signal or the second signal at random (e.g., random selection). For example, the tags may determine to use the Q value indicated by the first signal for determining the slot counter (e.g., random number selection) at random.

In some cases, a tag may use each Q value indicated by each signal until a slot counter for the tag is equal to a target value (e.g., zero), or until all Q values have been used to determine a tag's corresponding slot counter value. For example, in FIG. 10, the first signal may indicate a value of a slot counter parameter, Q, equal to four (Q=4), and the second signal may indicate a value of a slot counter parameter, Q, equal to two (Q=2). Tag 1 may first use the value of the slot counter parameter, Q, indicated by the first signal to initialize its slot counter. For example, Tag 1 initializes its slot counter by randomly selecting a number in the range of [0, 2^{Q}−1], where Q=4 (e.g., [0, 2⁴−1]=[0, 15]). In this example, Tag 1 may randomly select its slot counter to be equal to four (e.g., randomly select 4 from the range of [0, 15]). Because a value of Tag 1's slot counter is not equal to a target value (e.g., zero), Tag 1 may then use the value of the slot counter parameter, Q, indicated by the second signal to initialize its slot counter. For example, Tag 1 initializes its slot counter by randomly selecting a number in the range of [0, 2^{Q}−1], where Q=2 (e.g., [0, 2²−1]=[0, 3]). In some cases, Tag 1 may randomly select its slot counter to be equal to the target value (e.g., randomly select 0 from the range of [0,3]. As such, Tag 1 may choose to follow information (e.g., Δf_{w}) indicated by the second signal (given Tag 1 selected a slot counter value equal to the target value when using the value of the slot counter parameter, Q, indicated by the second signal). In some other cases, Tag 1 may randomly select its slot counter to be equal to two (e.g., randomly select 2 from the range of [0, 3]). Because (1) a value of Tag 1's slot counter is not equal to the target value (e.g., zero) and (2) all indicated slot counter parameter values have been used to determine a value of Tag 1's slot counter and none have resulted in Tag 1's slot counter being equal to the target value, Tag 1 may then use the value of the slot counter parameter, Q, indicated by the second signal to initialize its slot counter (or, in some other cases, the value of the slot counter parameter, Q, indicated by the first signal).

In certain aspects, to avoid collision of signals from the tags, the backscatter frequency used by the tags to backscatter signals to the reader may be shifted. In particular, as described with respect to FIG. 8, Tag 1 and Tag 2 may each select a shift frequency, Δfₜ, from a first resource pool based on an ID associated with each of Tag 1 and Tag 2. As such, in response to receiving the first signal (e.g., at frequency, f₁), Tag 1 and Tag 2 may each backscatter a signal to the reader at a frequency equal to (f₁+Δf_{w}+Δfₜ). Further, in response to receiving the second signal (e.g., at frequency, f₂), Tag 1 and Tag 2 may each backscatter a signal to the reader at a frequency equal to (f₂+Δf_{w}+Δfₜ).

For example, where Tag 1 may randomly choose to follow information (e.g., Δf_{w}=200) indicated by the first signal, Tag 1 may backscatter signals to the reader at a frequency equal to (f₁+Δf_{w}+Δfₜ=f₁+200+Δfₜ) and/or (f₁+Δf_{w}+Δfₜ=f₂+200+Δfₜ).

In the example of FIG. 10, it may be assumed that two of the four tags follow the first signal (e.g., at frequency, f₁) while the other two tags follow the second signal (e.g., at frequency, f₂).

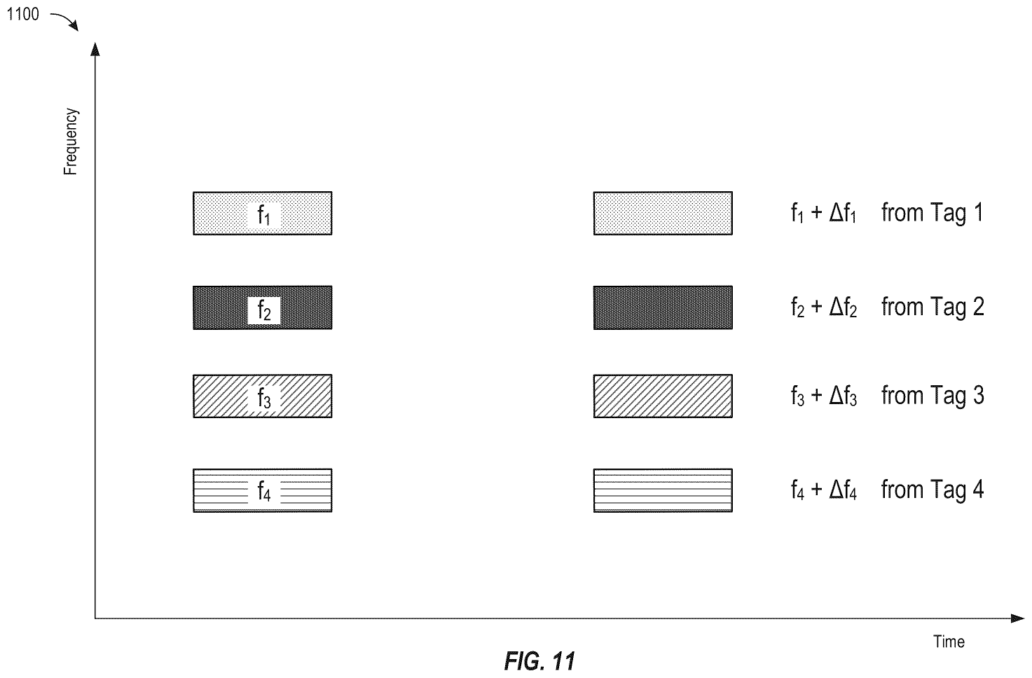

FIG. 11 illustrates example backscattering 1100 for FDMed transmission of multiple signals over multiple non-contiguous subcarriers. For example, as shown in FIG. 11, a first signal at a frequency, f₁, a second signal at a frequency, f₂, a third signal at a frequency, f₃, and a fourth signal at a frequency, f₄, may be FDMed in a transmission. The first signal may be assigned to a first subcarrier of the FDMed transmission, the second signal may be assigned to a second subcarrier of the FDMed transmission, the third signal may be assigned to a third subcarrier of the FDMed transmission, and the fourth signal may be assigned to a fourth subcarrier of the FDMed transmission. The first, second, third, and fourth subcarriers may be non-contiguous (e.g., discontinuous). The FDMed transmission may be transmitted (e.g., broadcast), from a reader, to a first tag, Tag 1, a second tag, Tag 2, a third tag, Tag 3, and a fourth tag, Tag 4 (e.g., where Tags 1-4 are passive RFID tags). Further, the first signal may indicate Δf_{w}=Δf₁, the second signal may indicate Δf_{w}=Δf₂, the third signal may indicate Δf_{w}=Δf₃, and the fourth signal may indicate Δf_{w}=Δf₄.

Unlike FIG. 10, in FIG. 11, because the first, second, third, and fourth signals are assigned to non-contiguous subcarriers, spacing (e.g., the gap) between each of the signals may be large enough such that each tag (e.g., Tags 1-4) only receives one of the multiple signals included in the FDMed transmission. For example, Tag 1 receives the first signal (e.g., without also receiving the other signals), Tag 2, receives the second signal, Tag 3 receives the third signal, and Tag 4 receives the fourth signal. As such, in response to receiving the first signal, Tag 1 backscatters data to the reader using information indicated by the first signal (e.g., using f₁ and Δf₁, such that a signal is backscattered to the reader at (f₁+Δf₁)). Similarly, in response to receiving the second signal, Tag 2 backscatters data to the reader using information indicated by the second signal (e.g., using f₂ and Δf₂, such that a signal is backscattered to the reader at (f₂+Δf₂)). In response to receiving the third signal, Tag 3 backscatters data to the reader using information indicated by the third signal (e.g., using f₃ and Δf₃, such that a signal is backscattered to the reader at (f₃+Δf₃)).)). In response to receiving the fourth signal, Tag 4 backscatters data to the reader using information indicated by the fourth signal (e.g., using f₄ and Δf₄, such that a signal is backscattered to the reader at (f₄+Δf₄)).

In some cases, there may be no fixed/formal assignments of the signals to specific tags. For example, the first signal may not be assigned to Tag 1, the second signal may not be assigned to Tag 2, etc. Accordingly, in this case, different tags may randomly select different frequency shifts (Δf_{w}) from a resource pool. However, this may, in some cases, increase the risk of collisions. For example, two tags randomly selecting different frequency shifts may result in a collision where the two tags choose the same frequency shift.

In certain aspects, to enable accessing of multiple passive RFID tags by a reader, each of the passive RFID tags may backscatter repetitions of a signal (e.g., in response to receiving a first signal broadcasted by the reader).

In certain aspects, different passive RFID tags use different time-frequency patterns for backscattering repetitions of a signal. For example, a first time-frequency pattern used by a first tag, Tag 1, to backscatter repetitions of a second signal to the reader (e.g., in response to receiving a first signal from the reader) may be different than a second time-frequency pattern used by a second tag, Tag 2, to backscatter repetitions of the second signal to the reader.

Thus, in some cases (e.g., a first option), the first time-frequency pattern used by Tag 1 for backscattering indicates, to the reader, an ID associated with Tag 1, while the second time-frequency pattern used by Tag 2 for backscattering indicates, to the reader, an ID associated with Tag 2. In this case, Tags 1 and 2 may backscatter the second signal without any modulation.

In some other cases (e.g., a second option), the first time-frequency pattern used by Tag 1 for backscattering indicates, to the reader, a portion of the ID associated with Tag 1 (e.g., less than all of the ID associated with Tag 1). Further, the second time-frequency pattern used by Tag 2 for backscattering indicates, to the reader, a portion of the ID associated with Tag 2 (e.g., less than all of the ID associated with Tag 2).

In some other cases, the first time-frequency pattern used by Tag 1 for backscattering and the second time-frequency pattern used by Tag for backscattering may not indicate an ID, nor a portion of the ID, associated with Tag 1 and Tag 2, respectively. Instead, in some cases, Tag 1 and Tag 2 may backscatter repetitions of the second signal at different times and frequencies. In some other cases, Tag 1 and Tag 2 may backscatter repetitions of the second signal at different times with a same frequency. However, a number of repetitions of backscattering the second signal may be different Tag 1 and Tag 2. For example, a higher priority passive RFID tag (e.g., or a passive RFID tag having higher priority data to backscatter) may backscatter the second signal more times than a lower priority passive RFID tag (e.g., or a passive RFID tag having lower priority data to backscatter) (e.g., the higher priority passive RFID tag may have a greater number of backscattering repetitions than the lower priority passive RFID tag). Thus, where a priority associated with Tag 1 is greater than a priority associated with Tag 2, Tag 1 may transmit more repetitions of the signal (e.g., via backscatter communication) than Tag 2.

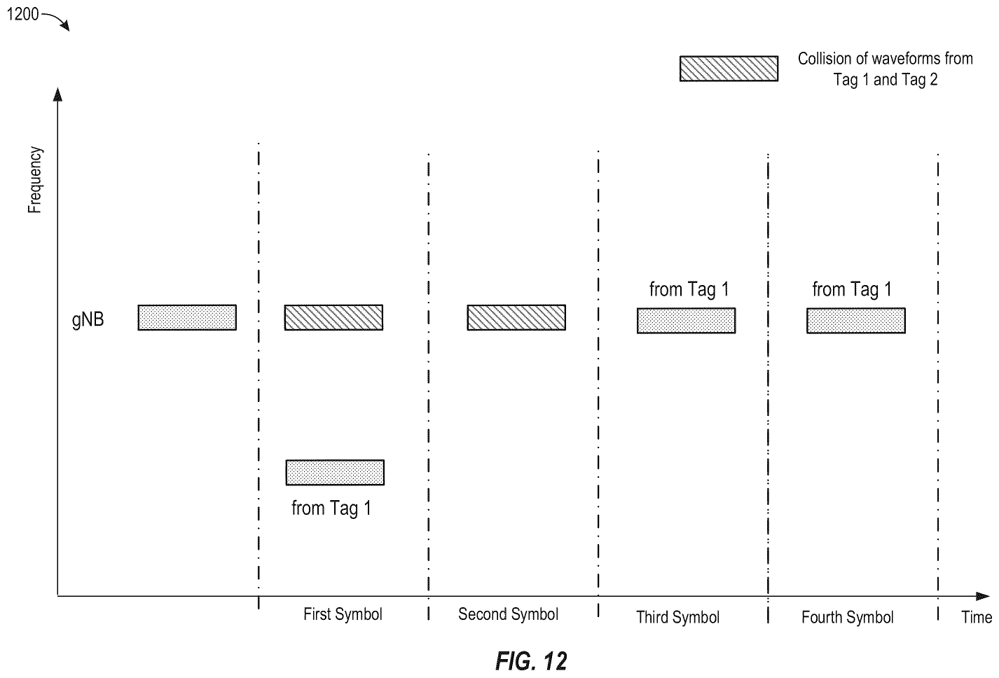

For example, FIG. 12 illustrates example backscattering 1200 using resources of different time-frequency patterns. FIG. 12 illustrates the third option described above where the time-frequency pattern used by different passive RFID tags for backscattering does not indicate an ID, nor a portion of an ID, associated with each of the different passive RFID tags.

As shown in FIG. 12, a reader (e.g., such as the illustrated gNB) transmits a first signal initiating an inventory round. In certain aspects, the reader transmits the first signal via broadcast communication. Further, as shown in FIG. 12, a first tag, Tag 1, and a second tag, Tag 2, (e.g., where Tag 1 and Tag 2 are passive RFID tags) receive the first signal.

In response to receiving the first signal, both Tag 1 and Tag 2 backscatter a second signal to the gNB. Tag 1 and Tag 2 backscatter the second signal by backscattering repetitions of the second signal. As illustrated, in some cases, Tag 1 and Tag 2 may backscatter the second signal using same time-frequency resource(s) (e.g., at a same time and at a same frequency). This may result in collision(s) of the second signal from Tag 1 and the second signal from Tag 2 (e.g., collisions of waveforms from Tag 1 and Tag 2). The gNB may not be able to resolve the collision (e.g., may not be able to distinguish/differentiate which data/signal is from which tag).

However, a priority associated with Tag 1 (or associated with data to be backscattered by Tag 1) may be higher than a priority associated with Tag 2 (or associated with data to be backscattered by Tag 2). Thus, Tag 1 may backscatter more repetitions of the second signal to the gNB than Tag 2. For example, as shown in FIG. 12, Tag 1 may transmit (repetitions of) the second signal in the third symbol and the fourth symbol. Tag 2 may not transmit (repetitions of) the second signal in the third symbol and the fourth symbol. As such, although the time-frequency pattern does not indicate information (e.g., an ID or a portion of an ID) associated with Tag 1, the gNB may know the signal is from Tag 1 given Tag 1 has a larger priority and a greater repetition of backscattering the second signal.

In certain aspects, the first option (e.g., the time-frequency pattern indicates an ID associated with a passive RFID tag), the second option (e.g., the time-frequency pattern indicates a portion of an ID associated with a passive RFID tag), and the third option (e.g., the time-frequency pattern does not indicate any portion of an ID associated with a passive RFID tag) described above may be used by passive RFID tags for backscattering. In certain aspects, a passive RFID tag with a highest priority, time stringent requirement, and/or energy level above a predetermined threshold may select to use the third option for backscattering. In certain aspects, a passive RFID tag with a lowest priority, a relaxed latency requirement, and/or limited energy may use the first option for backscattering. Accordingly, whether a time-frequency pattern used to backscatter a signal indicates an ID, a portion of the ID, or does not indicate any portion of the ID may be based on a priority associated with a passive RFID tag backscattering a signal using resources of the time-frequency pattern.

As mentioned, in certain aspects, enable accessing of multiple passive RFID tags by a reader, each of the passive RFID tags may backscatter repetitions of a signal (e.g., in response to receiving a first signal broadcasted by the reader). Further, different passive RFID tags may use different time-frequency patterns for backscattering repetitions of the signal.

In certain aspects, resources of a time-frequency pattern used by a passive RFID tag (e.g., for backscattering repetitions of a signal) are selected from one or more resource pools. The resources of the time-frequency pattern may have frequencies generated by applying frequency shifts, Δfₜ, to a frequency of a signal received, at the passive RFID tag, from a reader. The frequency shifts may include positive values or negative values.

In certain aspects, resources of the time-frequency pattern used by the passive RFID tag (e.g., for backscattering repetitions of a signal) are selected based on: a number of the repetitions of the signal (e.g., to be transmitted by the tag, an ID associated with passive RFID tag, and a variable, x. For example, the resources may be selected from one or more resource pools based on ((the number of repetitions of the signal)+ (Tag ID)) mod (the choices of Δfₜ).

In certain other aspects, an ID associated with the passive RFID tag (e.g., backscattering repetitions of the signal) is divided into a plurality of segments, and the resources of the time-frequency pattern used by the passive RFID tag (e.g., for backscattering repetitions of a signal) are selected based on one of the plurality of segments. Further, the number of repetitions of the signal may be equal to a number of the plurality of segments the ID associated with the passive RFID tag is divided into.

For example, an ID associated with a passive RFID tag may be equal to a 9-digit number (e.g., 000111010). The 9-digit number may be broken into three segments (e.g., 000 as the first segment, 111 as the second segment, and 010 as the third segment). Accordingly, the passive RFID tag may backscatter three repetitions of the signal (e.g., number of repetitions=number of segments). Resources of the time-frequency pattern may be selected using each of the three segments. For example, the resources may have a frequency shifted by a frequency shift, Δfₜ=(One segment of the Tag's ID) mod (the choices of Δfₜ).

In certain aspects, resources of a time-frequency pattern used by a passive RFID tag (e.g., for backscattering repetitions of a signal) are selected from a single resource pool. For example, resources of the time-frequency pattern are selected from a single resource pool when the signal transmitted (e.g., broadcast) by the reader is a single band signal. Accordingly, in some cases, the resources of the time-frequency pattern may be resources at a first symbol and at a second symbol selected from a same resource pool.

In certain other aspects, resources of a time-frequency pattern used by a passive RFID tag (e.g., for backscattering repetitions of a signal) are selected from two different resource pools. For example, resources of the time-frequency pattern are selected from two different resource pools when the signal transmitted (e.g., broadcast) by the reader is a double band signal. Accordingly, in some cases, the resources of the time-frequency pattern may be resources at a first symbol selected from a first resource pool and resources at a second symbol selected from a second resource pool.

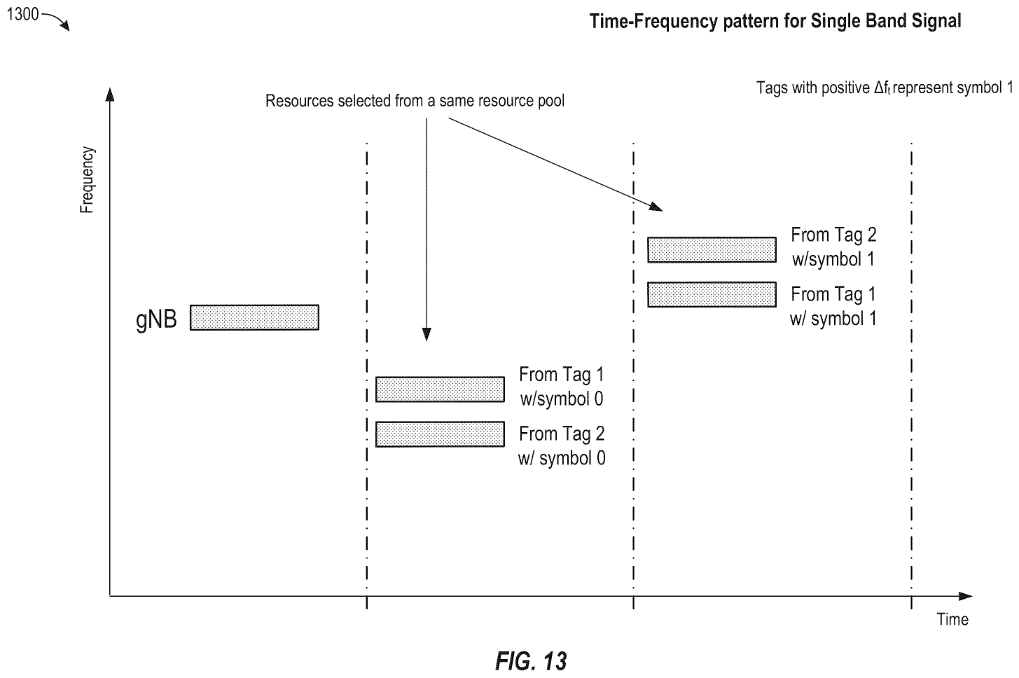

FIG. 13 illustrates example backscattering 1300 using resources at different symbols selected from a single resource pool. FIG. 13 illustrates a scenario where a signal transmitted (e.g., broadcast) by a reader is a single band signal.

As shown in FIG. 13, the reader (e.g., such as the illustrated gNB) transmits a first signal initiating an inventory round. In certain aspects, the reader transmits the first signal via broadcast communication. As mentioned, the first signal is a single band signal. Further, as shown in FIG. 13, a first tag, Tag 1, and a second tag, Tag 2, (e.g., where Tag 1 and Tag 2 are passive RFID tags) receive the first signal.

In response to receiving the first signal, both Tag 1 and Tag 2 backscatter a second signal to the gNB. Tag 1 and Tag 2 backscatter the second signal by backscattering repetitions of the second signal. As illustrated, Tag 1 backscatters repetitions of the second signal using resources of a first time-frequency pattern. The resources of the first time-frequency pattern used by Tag 1 includes resources at a first symbol and at a second symbol selected from a same resource pool. Further, Tag 2 also backscatters repetitions of the second signal using resources of a second time-frequency pattern. The resources of the second time-frequency pattern used by Tag 2 includes resources at a first symbol and at a second symbol selected from the same resource pool. The resources of the first time-frequency pattern used by Tag 1 and the resources of the second time-frequency pattern used by Tag 2 may be different resources selected from a same resource pool.

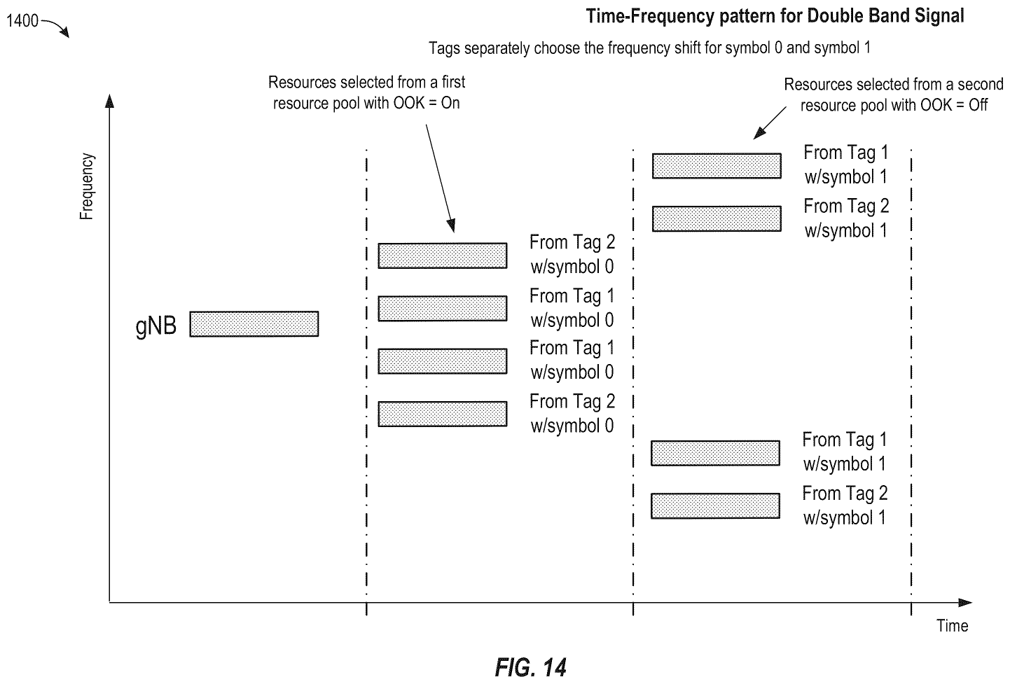

FIG. 14 illustrates example backscattering 1400 using resources at different symbols selected from different resource pools. FIG. 14 illustrates a scenario where a signal transmitted (e.g., broadcast) by a reader is a double band signal.

As shown in FIG. 14, the reader (e.g., such as the illustrated gNB) transmits a first signal initiating an inventory round. In certain aspects, the reader transmits the first signal via broadcast communication. As mentioned, the first signal is a double band signal. Further, as shown in FIG. 14, a first tag, Tag 1, and a second tag, Tag 2, (e.g., where Tag 1 and Tag 2 are passive RFID tags) receive the first signal.

In response to receiving the first signal, both Tag 1 and Tag 2 backscatter a second signal to the gNB. Tag 1 and Tag 2 backscatter the second signal by backscattering repetitions of the second signal. As illustrated, Tag 1 and Tag 2 separately choose frequency shifts, for backscattering signals to the gNB, for symbol 0 and symbol 1. In other words, the modulation may be assumed to be an on off keying (OOK) technique; thus, separate resources may be used for OOK=On and OOK=Off. In certain aspects, when OOK=On, resources are selected from a first resource pool. In certain aspects, when OOK=Off, resources are selected from a second resource pool, where the second resource pool is different than the first resource pool. In certain aspects, symbol 0 refers to OOK=On and symbol 1 refers to OOK=Off.

In certain aspects, subsequent to transmitting (e.g., broadcasting), by the gNB, the first signal (as shown in FIGS. 13 and 14), the gNB may further transmit frame-sync information for Tag 1 and Tag 2 for time synchronization.

### Example Operations of a First Receiver

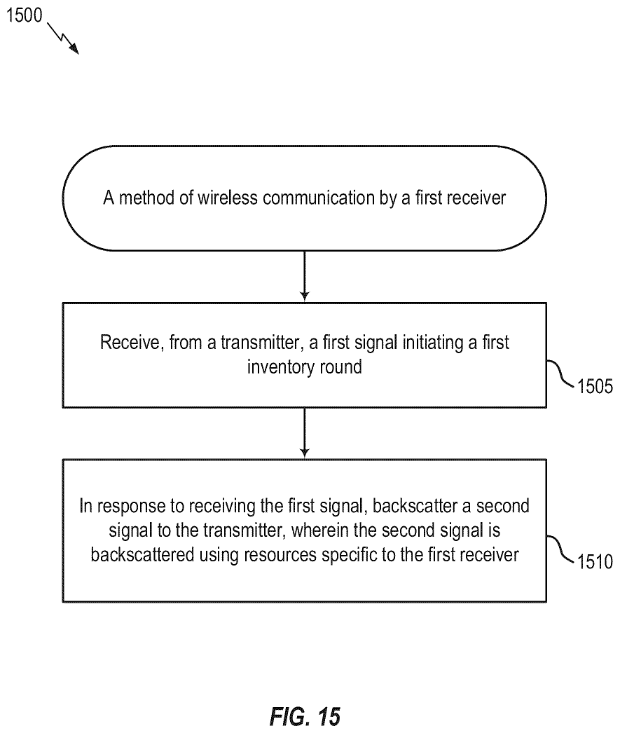

FIG. 15 shows an example of a method 1500 of wireless communication by a first receiver. In some aspects, the first receiver is a UE, such as a UE 104 of FIGS. 1 and 3.

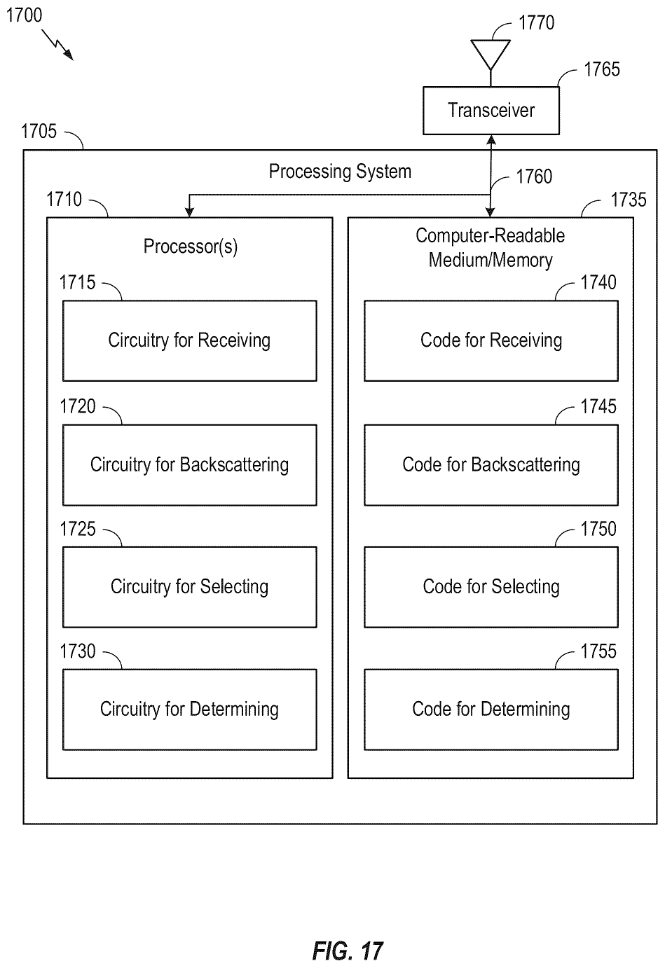

Method 1500 begins at step 1505 with receiving, from a transmitter, a first signal initiating a first inventory round. In some cases, the operations of this step refer to, or may be performed by, circuitry for receiving and/or code for receiving as described with reference to FIG. 17.

Method 1500 then proceeds to step 1510 with, in response to receiving the first signal, backscattering a second signal to the transmitter, wherein the second signal is backscattered using resources specific to the first receiver. In some cases, the operations of this step refer to, or may be performed by, circuitry for backscattering and/or code for backscattering as described with reference to FIG. 17.

In some aspects, the resources specific to the first receiver comprise at least one of: a first time-frequency resource, the first time-frequency resource being different than a second time-frequency resource used by a second receiver to backscatter the second signal; or a first OCC different than a second OCC used by the second receiver to backscatter the second signal.

In some aspects, the resources specific to the first receiver comprise at least the first time-frequency resource, the first time-frequency resource being different than the second time-frequency resource used by the second receiver to backscatter the second signal; the first time-frequency resource has a first frequency shifted by a first shift frequency from a frequency of the first signal; and the second time-frequency resource has a second frequency shifted by a second shift frequency from the frequency of the first signal.

In some aspects, the method 1500 further includes selecting the first shift frequency from a plurality of shift frequencies associated with the first signal based on an identifier associated with the first receiver. In some cases, the operations of this step refer to, or may be performed by, circuitry for selecting and/or code for selecting as described with reference to FIG. 17.

In some aspects, the shift frequencies associated with the first signal comprise positive values or negative values when the first signal comprises a double band signal; or the shift frequencies associated with the first signal comprise positive values and negative values when the first signal comprises a single band signal.

In some aspects, the shift frequencies associated with the first signal comprise values based on the frequency of the first signal.

In some aspects, the resources specific to the first receiver comprise at least the first OCC different than the second OCC used by the second receiver to backscatter the second signal.

In some aspects, the method 1500 further includes selecting the first OCC from a plurality of OCCs predefined for: at least the first receiver and the second receiver, or the first receiver only. In some cases, the operations of this step refer to, or may be performed by, circuitry for selecting and/or code for selecting as described with reference to FIG. 17.

In some aspects, the first receiver selects the first OCC is at random.

In some aspects, the resources specific to the first receiver comprise at least the first OCC different than the second OCC used by the second receiver to backscatter the second signal; and the first OCC is unique to the first receiver.

In some aspects, the first signal is assigned to a first subcarrier of a frequency division multiplexed transmission of multiple signals, including the first signal, over multiple contiguous subcarriers.

In some aspects, the resources specific to the first receiver comprise at least the first time-frequency resource, the first time-frequency resource being different than the second time-frequency resource used by the second receiver to backscatter the second signal; the first time-frequency resource has a first frequency shifted from a frequency of the first signal by a first shift frequency and a frequency indicated by the first signal; and the second time-frequency resource has a second frequency shifted from the frequency of the first signal by a second shift frequency and the frequency indicated by the first signal.

In some aspects, the method 1500 further includes selecting the frequency indicated by the first signal among a plurality of frequencies indicated by the multiple signals at random. In some cases, the operations of this step refer to, or may be performed by, circuitry for selecting and/or code for selecting as described with reference to FIG. 17.

In some aspects, each of the multiple signals, including the first signal, indicates a different value for a slot-counter parameter.

In some aspects, the method 1500 further includes selecting a first value for a slot-counter as zero based on a first value for the slot-counter parameter indicated by the first signal, wherein the first receiver backscatters the second signal to the transmitter based on the first receiver selecting the first value for the slot-counter to be zero. In some cases, the operations of this step refer to, or may be performed by, circuitry for selecting and/or code for selecting as described with reference to FIG. 17.

In some aspects, the method 1500 further includes determining to use the first value for the slot-counter parameter indicated by the first signal for selecting the first value for the slot-counter based on the first value for the slot-counter parameter based on a type of data to backscatter via the second signal. In some cases, the operations of this step refer to, or may be performed by, circuitry for determining and/or code for determining as described with reference to FIG. 17.

In some aspects, the method 1500 further includes determining to use the first value for the slot-counter parameter indicated by the first signal for selecting the first value at random. In some cases, the operations of this step refer to, or may be performed by, circuitry for determining and/or code for determining as described with reference to FIG. 17.

In some aspects, the method 1500 further includes determining to use the first value for the slot-counter parameter indicated by the first signal for selecting the first value for the slot-counter based on the first value for the slot-counter parameter indicated by the first signal causing the first receiver to select the first value for the slot-counter equal to zero. In some cases, the operations of this step refer to, or may be performed by, circuitry for determining and/or code for determining as described with reference to FIG. 17.

In some aspects, the method 1500 further includes determining to use a first value for a slot-counter parameter indicated by the first signal for selecting a first value for a slot-counter based on the values for the slot-counter parameter indicated by the multiple signals, other than the first signal, causing the first receiver not to select a first value for the slot-counter equal to zero. In some cases, the operations of this step refer to, or may be performed by, circuitry for determining and/or code for determining as described with reference to FIG. 17.

In some aspects, the method 1500 further includes selecting a first value for a slot-counter based on a first value for the slot-counter parameter indicated by the first signal. In some cases, the operations of this step refer to, or may be performed by, circuitry for selecting and/or code for selecting as described with reference to FIG. 17.

In some aspects, the method 1500 further includes selecting the frequency indicated by the first signal among a plurality of frequencies indicated by the multiple signals based on an identifier of the first receiver. In some cases, the operations of this step refer to, or may be performed by, circuitry for selecting and/or code for selecting as described with reference to FIG. 17.

In some aspects, the method 1500 further includes receiving, from the transmitter, a third signal initiating a second inventory round, wherein the third signal is assigned to a first subcarrier of a frequency division multiplexed transmission of multiple signals, including the third signal, over multiple non-contiguous subcarriers. In some cases, the operations of this step refer to, or may be performed by, circuitry for receiving and/or code for receiving as described with reference to FIG. 17.

In some aspects, the method 1500 further includes, in response to receiving the third signal, backscattering a fourth signal via a time-frequency resource to the receiver, the time-frequency resource having a frequency shifted by a shift frequency from a frequency of the third signal. In some cases, the operations of this step refer to, or may be performed by, circuitry for backscattering and/or code for backscattering as described with reference to FIG. 17.

In some aspects, backscattering the second signal to the transmitter comprises backscattering repetitions of the second signal at: different times and frequencies; or different times with a same frequency.

In some aspects, a number of the repetitions of the second signal is based on a priority associated with the first receiver.

In some aspects, backscattering the second signal to the transmitter comprises backscattering repetitions of the second signal using resources of a time-frequency pattern, the time-frequency pattern indicates to the transmitter: an ID associated with the first receiver; or a portion of the ID associated with the first receiver.

In some aspects, the time-frequency pattern indicates, to the transmitter, the ID or the portion of the ID based on a priority associated with the first receiver.

In some aspects, the time-frequency pattern comprises resources selected from one or more resource pools based on: a number of the repetitions of the second signal; the ID associated with the first receiver; and a variable.

In some aspects, the time-frequency pattern comprises: resources at a first symbol selected from a first resource pool; and resources at a second symbol selected from a second resource pool.

In some aspects, the resources of the time-frequency pattern have frequencies generated by applying frequency shifts to a frequency of the first signal; and the frequency shifts comprise positive values or negative values.

In some aspects, an ID associated with the first receiver is divided into a plurality of segments; and backscattering the second signal to the transmitter comprises backscattering repetitions of the second signal using resources of a time-frequency pattern, wherein each of the resources of the time-frequency pattern is selected from one or more resource pools based on one of the plurality of segments.

In some aspects, a number of the repetitions of the second signal is equal to a number of the plurality of segments the ID associated with the first receiver is divided into.

In one aspect, method 1500, or any aspect related to it, may be performed by an apparatus, such as communications device 1700 of FIG. 17, which includes various components operable, configured, or adapted to perform the method 1500. Communications device 1700 is described below in further detail.

Note that FIG. 15 is just one example of a method, and other methods including fewer, additional, or alternative steps are possible consistent with this disclosure.

### Example Operations of a Transmitter

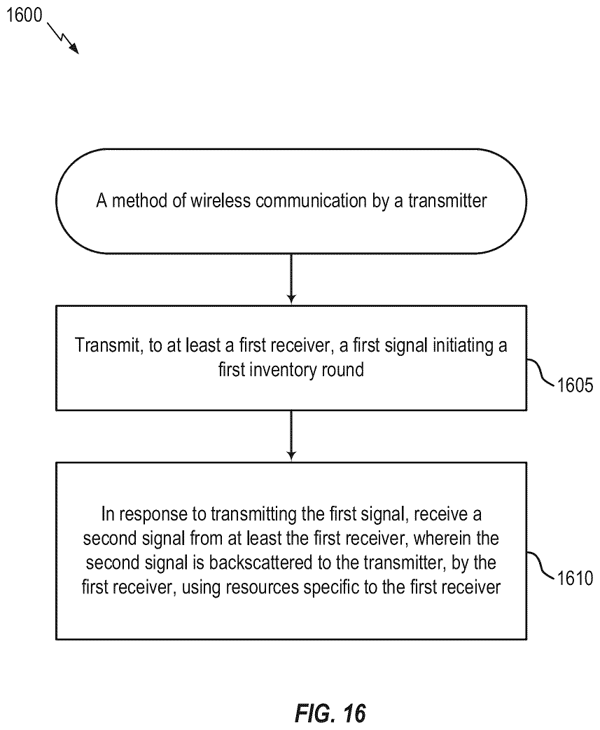

FIG. 16 shows an example of a method 1600 of wireless communication by a transmitter. In some aspects, the transmitter is a network entity, such as a BS 102 of FIGS. 1 and 3, or a disaggregated base station as discussed with respect to FIG. 2.

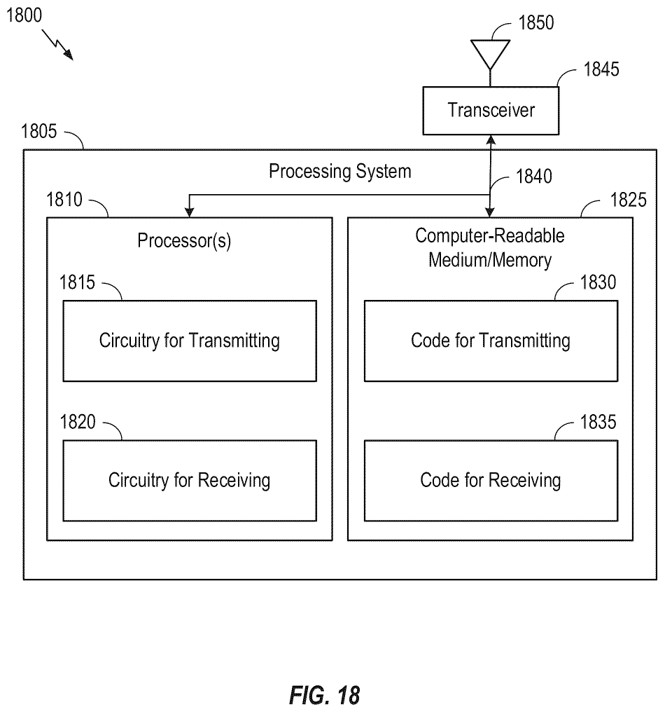

Method 1600 begins at step 1605 with transmitting, to at least a first receiver, a first signal initiating a first inventory round. In some cases, the operations of this step refer to, or may be performed by, circuitry for transmitting and/or code for transmitting as described with reference to FIG. 18.

Method 1600 then proceeds to step 1610 with, in response to transmitting the first signal, receiving a second signal from at least the first receiver, wherein the second signal is backscattered to the transmitter, by the first receiver, using resources specific to the first receiver. In some cases, the operations of this step refer to, or may be performed by, circuitry for receiving and/or code for receiving as described with reference to FIG. 18.

In some aspects, the transmitter receives the second signal from the first receiver and a second receiver; and the resources specific to the first receiver comprise at least one of: a first time-frequency resource, the first time-frequency resource being different than a second time-frequency resource used by the second receiver to backscatter the second signal to the transmitter, or a first OCC different than a second OCC used by the second receiver to backscatter the second signal to the transmitter.

In some aspects, the resources specific to the first receiver comprise at least the first time-frequency resource, the first time-frequency resource being different than the second time-frequency resource used by the second receiver to backscatter the second signal to the transmitter; the first time-frequency resource has a first frequency shifted by a first shift frequency from a frequency of the first signal; and the second time-frequency resource has a second frequency shifted by a second shift frequency from the frequency of the first signal.

In some aspects, the first shift frequency is selected from a plurality of shift frequencies associated with the first signal based on an identifier associated with the first receiver.

In some aspects, the shift frequencies associated with the first signal comprise positive values or negative values when the first signal comprises a double band signal; or the shift frequencies associated with the first signal comprise positive values and negative values when the first signal comprises a single band signal.

In some aspects, the shift frequencies associated with the first signal comprise values based on the frequency of the first signal.

In some aspects, the resources specific to the first receiver comprise at least the first OCC different than the second OCC used by the second receiver to backscatter the second signal to the transmitter; and the first OCC is selected from a plurality of OCCs predefined for: at least the first receiver and the second receiver, or the first receiver only.

In some aspects, the first OCC is selected at random.

In some aspects, the resources specific to the first receiver comprise at least the first OCC different than the second OCC used by the second receiver to backscatter the second signal to the transmitter; and the first OCC is unique to the first receiver.

In some aspects, the first signal is assigned to a first subcarrier of a frequency division multiplexed transmission of multiple signals, including the first signal, over multiple contiguous subcarriers.

In some aspects, the resources specific to the first receiver comprise at least the first time-frequency resource, the first time-frequency resource being different than the second time-frequency resource used by the second receiver to backscatter the second signal to the transmitter; the first time-frequency resource has a first frequency shifted from a frequency of the first signal by a first shift frequency and a frequency indicated by the first signal; and the second time-frequency resource has a second frequency shifted from the frequency of the first signal by a second shift frequency and the frequency indicated by the first signal.

In some aspects, the frequency indicated by the first signal is randomly selected from a plurality of frequencies indicated by the multiple signals.

In some aspects, each of the multiple signals, including the first signal, indicates a different value for a slot-counter parameter.

In some aspects, the second signal is received from at least the first receiver when the first receiver selects a first value for a slot-counter to be zero based on a first value for the slot-counter parameter indicated by the first signal.

In some aspects, the frequency indicated by the first signal is selected from a plurality of frequencies indicated by the multiple signals based on an identifier of the first receiver.

In some aspects, the method 1600 further includes transmitting, to the first receiver, a third signal initiating a second inventory round, wherein the third signal is assigned to a first subcarrier of a frequency division multiplexed transmission of multiple signals, including the third signal, over multiple non-contiguous subcarriers. In some cases, the operations of this step refer to, or may be performed by, circuitry for transmitting and/or code for transmitting as described with reference to FIG. 18.

In some aspects, the method 1500 further includes, in response to transmitting the third signal, receiving a fourth signal via a time-frequency resource specific to the first receiver, the time-frequency resource having a frequency shifted by a shift frequency from a frequency of the third signal. In some cases, the operations of this step refer to, or may be performed by, circuitry for receiving and/or code for receiving as described with reference to FIG. 18.

In some aspects, receiving the second signal from at least the first receiver comprises receiving repetitions of the second signal at: different times and frequencies; or different times with a same frequency.

In some aspects, a number of the repetitions of the second signal is based on a priority associated with the first receiver.

In some aspects, receiving the second signal from at least the first receiver comprises receiving repetitions of the second signal via resources of a time-frequency pattern, wherein the time-frequency pattern indicates: an ID associated with the first receiver; or a portion of the ID associated with the first receiver.

In some aspects, the time-frequency pattern indicates, to the transmitter, the ID or the portion of the ID based on a priority associated with the first receiver.

In some aspects, the time-frequency pattern comprises resources from one or more resource pools based on: a number of the repetitions of the second signal; the ID associated with the first receiver; and a variable.

In some aspects, the time-frequency pattern comprises: resources at a first symbol from a first resource pool; and resources at a second symbol from a second resource pool.

In some aspects, the resources of the time-frequency pattern have frequencies generated by applying frequency shifts to a frequency of the first signal; and the frequency shifts comprise positive values or negative values.

In some aspects, an ID associated with the first receiver is divided into a plurality of segments; and receiving the second signal from at least the first receiver comprises receiving repetitions of the second signal via resources of a time-frequency pattern, wherein each of the resources of the time-frequency pattern is selected from one or more resource pools based on one of the plurality of segments.

In some aspects, a number of the repetitions of the second signal is equal to a number of the plurality of segments the ID associated with the first receiver is divided into.

In one aspect, method 1600, or any aspect related to it, may be performed by an apparatus, such as communications device 1800 of FIG. 18, which includes various components operable, configured, or adapted to perform the method 1600. Communications device 1800 is described below in further detail.

Note that FIG. 16 is just one example of a method, and other methods including fewer, additional, or alternative steps are possible consistent with this disclosure.

### Example Communications Devices

FIG. 17 depicts aspects of an example communications device 1700. In some aspects, communications device 1700 is a first receiver or a user equipment, such as UE 104 described above with respect to FIGS. 1 and 3.

The communications device 1700 includes a processing system 1705 coupled to the transceiver 1765 (e.g., a transmitter and/or a receiver). The transceiver 1765 is configured to transmit and receive signals for the communications device 1700 via the antenna 1770, such as the various signals as described herein. The processing system 1705 may be configured to perform processing functions for the communications device 1700, including processing signals received and/or to be transmitted by the communications device 1700.

The processing system 1705 includes one or more processors 1710. In various aspects, the one or more processors 1710 may be representative of one or more of receive processor 358, transmit processor 364, TX MIMO processor 366, and/or controller/processor 380, as described with respect to FIG. 3. The one or more processors 1710 are coupled to a computer-readable medium/memory 1735 via a bus 1760. In certain aspects, the computer-readable medium/memory 1735 is configured to store instructions (e.g., computer-executable code) that when executed by the one or more processors 1710, cause the one or more processors 1710 to perform the method 1500 described with respect to FIG. 15, or any aspect related to it. Note that reference to a processor performing a function of communications device 1700 may include one or more processors 1710 performing that function of communications device 1700.

In the depicted example, computer-readable medium/memory 1735 stores code (e.g., executable instructions), such as code for receiving 1740, code for backscattering 1745, code for selecting 1750, and code for determining 1755. Processing of the code for receiving 1740, code for backscattering 1745, code for selecting 1750, and code for determining 1755 may cause the communications device 1700 to perform the method 1500 described with respect to FIG. 15, or any aspect related to it.

The one or more processors 1710 include circuitry configured to implement (e.g., execute) the code stored in the computer-readable medium/memory 1735, including circuitry such as circuitry for receiving 1715, circuitry for backscattering 1720, circuitry for selecting 1725, and circuitry for determining 1730. Processing with circuitry for receiving 1715, circuitry for backscattering 1720, circuitry for selecting 1725, and circuitry for determining 1730 may cause the communications device 1700 to perform the method 1500 described with respect to FIG. 15, or any aspect related to it.

Various components of the communications device 1700 may provide means for performing the method 1500 described with respect to FIG. 15, or any aspect related to it. For example, means for transmitting, sending or outputting for transmission may include transceivers 354 and/or antenna(s) 352 of the UE 104 illustrated in FIG. 3 and/or the transceiver 1765 and the antenna 1770 of the communications device 1700 in FIG. 17. Means for receiving or obtaining may include transceivers 354 and/or antenna(s) 352 of the UE 104 illustrated in FIG. 3 and/or the transceiver 1765 and the antenna 1770 of the communications device 1700 in FIG. 17.

FIG. 18 depicts aspects of an example communications device 1800. In some aspects, communications device 1800 is a network entity, such as BS 102 of FIGS. 1 and 3, or a disaggregated base station as discussed with respect to FIG. 2.

The communications device 1800 includes a processing system 1805 coupled to the transceiver 1845 (e.g., a transmitter and/or a receiver). The transceiver 1845 is configured to transmit and receive signals for the communications device 1800 via the antenna 1850, such as the various signals as described herein. The processing system 1805 may be configured to perform processing functions for the communications device 1800, including processing signals received and/or to be transmitted by the communications device 1800.

The processing system 1805 includes one or more processors 1810. In various aspects, the one or more processors 1810 may be representative of one or more of receive processor 338, transmit processor 320, TX MIMO processor 330, and/or controller/processor 340, as described with respect to FIG. 3. The one or more processors 1810 are coupled to a computer-readable medium/memory 1825 via a bus 1840. In certain aspects, the computer-readable medium/memory 1825 is configured to store instructions (e.g., computer-executable code) that when executed by the one or more processors 1810, cause the one or more processors 1810 to perform the method 1600 described with respect to FIG. 16, or any aspect related to it. Note that reference to a processor performing a function of communications device 1800 may include one or more processors 1810 performing that function of communications device 1800.

In the depicted example, computer-readable medium/memory 1825 stores code (e.g., executable instructions), such as code for transmitting 1830 and code for receiving 1835. Processing of the code for transmitting 1830 and code for receiving 1835 may cause the communications device 1800 to perform the method 1600 described with respect to FIG. 16, or any aspect related to it.

The one or more processors 1810 include circuitry configured to implement (e.g., execute) the code stored in the computer-readable medium/memory 1825, including circuitry such as circuitry for transmitting 1815 and circuitry for receiving 1820. Processing with circuitry for transmitting 1815 and circuitry for receiving 1820 may cause the communications device 1800 to perform the method 1600 described with respect to FIG. 16, or any aspect related to it.

Various components of the communications device 1800 may provide means for performing the method 1600 described with respect to FIG. 16, or any aspect related to it. For example, means for transmitting, sending or outputting for transmission may include transceivers 332 and/or antenna(s) 334 of the BS 102 illustrated in FIG. 3 and/or the transceiver 1845 and the antenna 1850 of the communications device 1800 in FIG. 18. Means for receiving or obtaining may include transceivers 332 and/or antenna(s) 334 of the BS 102 illustrated in FIG. 3 and/or the transceiver 1845 and the antenna 1850 of the communications device 1800 in FIG. 18.

### Example Clauses

Implementation examples are described in the following numbered clauses:
Clause 1: A method of wireless communication by a first receiver, comprising: receiving, from a transmitter, a first signal initiating a first inventory round; and in response to receiving the first signal, backscattering a second signal to the transmitter, wherein the second signal is backscattered using resources specific to the first receiver.
Clause 2: The method of Clause 1, wherein the resources specific to the first receiver comprise at least one of: a first time-frequency resource, the first time-frequency resource being different than a second time-frequency resource used by a second receiver to backscatter the second signal; or a first OCC different than a second OCC used by the second receiver to backscatter the second signal.
Clause 3: The method of Clause 2, wherein: the resources specific to the first receiver comprise at least the first time-frequency resource, the first time-frequency resource being different than the second time-frequency resource used by the second receiver to backscatter the second signal; the first time-frequency resource has a first frequency shifted by a first shift frequency from a frequency of the first signal; and the second time-frequency resource has a second frequency shifted by a second shift frequency from the frequency of the first signal.
Clause 4: The method of Clause 3, further comprising: selecting the first shift frequency from a plurality of shift frequencies associated with the first signal based on an identifier associated with the first receiver.
Clause 5: The method of Clause 4, wherein: the shift frequencies associated with the first signal comprise positive values or negative values when the first signal comprises a double band signal; or the shift frequencies associated with the first signal comprise positive values and negative values when the first signal comprises a single band signal.
Clause 6: The method of Clause 4, wherein: the shift frequencies associated with the first signal comprise values based on the frequency of the first signal.
Clause 7: The method of Clause 2, wherein: the resources specific to the first receiver comprise at least the first OCC different than the second OCC used by the second receiver to backscatter the second signal; and the method further comprises selecting the first OCC from a plurality of OCCs predefined for: at least the first receiver and the second receiver, or the first receiver only.
Clause 8: The method of Clause 7, wherein the first receiver selects the first OCC is at random.
Clause 9: The method of Clause 2, wherein: the resources specific to the first receiver comprise at least the first OCC different than the second OCC used by the second receiver to backscatter the second signal; and the first OCC is unique to the first receiver.
Clause 10: The method of Clause 2, wherein: the first signal is assigned to a first subcarrier of a frequency division multiplexed transmission of multiple signals, including the first signal, over multiple contiguous subcarriers.
Clause 11: The method of Clause 10, wherein: the resources specific to the first receiver comprise at least the first time-frequency resource, the first time-frequency resource being different than the second time-frequency resource used by the second receiver to backscatter the second signal; the first time-frequency resource has a first frequency shifted from a frequency of the first signal by a first shift frequency and a frequency indicated by the first signal; and the second time-frequency resource has a second frequency shifted from the frequency of the first signal by a second shift frequency and the frequency indicated by the first signal.
Clause 12: The method of Clause 11, further comprising: selecting the frequency indicated by the first signal among a plurality of frequencies indicated by the multiple signals at random.
Clause 13: The method of Clause 12, wherein each of the multiple signals, including the first signal, indicates a different value for a slot-counter parameter.
Clause 14: The method of Clause 13, further comprising: selecting a first value for a slot-counter as zero based on a first value for the slot-counter parameter indicated by the first signal, wherein the first receiver backscatters the second signal to the transmitter based on the first receiver selecting the first value for the slot-counter to be zero.
Clause 15: The method of Clause 14, further comprising: determining to use the first value for the slot-counter parameter indicated by the first signal for selecting the first value for the slot-counter based on the first value for the slot-counter parameter based on a type of data to backscatter via the second signal.
Clause 16: The method of Clause 14, further comprising: determining to use the first value for the slot-counter parameter indicated by the first signal for selecting the first value at random.
Clause 17: The method of Clause 14, further comprising: determining to use the first value for the slot-counter parameter indicated by the first signal for selecting the first value for the slot-counter based on the first value for the slot-counter parameter indicated by the first signal causing the first receiver to select the first value for the slot-counter equal to zero.
Clause 18: The method of Clause 13, further comprising: determining to use a first value for a slot-counter parameter indicated by the first signal for selecting a first value for a slot-counter based on the values for the slot-counter parameter indicated by the multiple signals, other than the first signal, causing the first receiver not to select a first value for the slot-counter equal to zero; and selecting a first value for a slot-counter based on a first value for the slot-counter parameter indicated by the first signal.
Clause 19: The method of Clause 11, further comprising: selecting the frequency indicated by the first signal among a plurality of frequencies indicated by the multiple signals based on an identifier of the first receiver.
Clause 20: The method of any one of Clauses 1-19, further comprising: receiving, from the transmitter, a third signal initiating a second inventory round, wherein the third signal is assigned to a first subcarrier of a frequency division multiplexed transmission of multiple signals, including the third signal, over multiple non-contiguous subcarriers; and in response to receiving the third signal, backscattering a fourth signal via a time-frequency resource to the receiver, the time-frequency resource having a frequency shifted by a shift frequency from a frequency of the third signal.
Clause 21: The method of any one of Clauses 1-20, wherein backscattering the second signal to the transmitter comprises backscattering repetitions of the second signal at: different times and frequencies; or different times with a same frequency.
Clause 22: The method of Clause 21, wherein a number of the repetitions of the second signal is based on a priority associated with the first receiver.
Clause 23: The method of any one of Clauses 1-22, wherein backscattering the second signal to the transmitter comprises backscattering repetitions of the second signal using resources of a time-frequency pattern, the time-frequency pattern indicates to the transmitter: an ID associated with the first receiver; or a portion of the ID associated with the first receiver.
Clause 24: The method of Clause 23, wherein the time-frequency pattern indicates, to the transmitter, the ID or the portion of the ID based on a priority associated with the first receiver.
Clause 25: The method of Clause 23, wherein the time-frequency pattern comprises resources selected from one or more resource pools based on: a number of the repetitions of the second signal; the ID associated with the first receiver; and a variable.
Clause 26: The method of Clause 23, wherein the time-frequency pattern comprises: resources at a first symbol selected from a first resource pool; and resources at a second symbol selected from a second resource pool.
Clause 27: The method of Clause 23, wherein: the resources of the time-frequency pattern have frequencies generated by applying frequency shifts to a frequency of the first signal; and the frequency shifts comprise positive values or negative values.
Clause 28: The method of any one of Clauses 1-27, wherein: an ID associated with the first receiver is divided into a plurality of segments; and backscattering the second signal to the transmitter comprises backscattering repetitions of the second signal using resources of a time-frequency pattern, wherein each of the resources of the time-frequency pattern is selected from one or more resource pools based on one of the plurality of segments.
Clause 29: The method of Clause 28, wherein a number of the repetitions of the second signal is equal to a number of the plurality of segments the ID associated with the first receiver is divided into.
Clause 30: A method of wireless communication by a transmitter, comprising: transmitting, to at least a first receiver, a first signal initiating a first inventory round; and in response to transmitting the first signal, receiving a second signal from at least the first receiver, wherein the second signal is backscattered to the transmitter, by the first receiver, using resources specific to the first receiver.
Clause 31: The method of Clause 30, wherein: the transmitter receives the second signal from the first receiver and a second receiver; and the resources specific to the first receiver comprise at least one of: a first time-frequency resource, the first time-frequency resource being different than a second time-frequency resource used by the second receiver to backscatter the second signal to the transmitter, or a first OCC different than a second OCC used by the second receiver to backscatter the second signal to the transmitter.
Clause 32: The method of Clause 31, wherein: the resources specific to the first receiver comprise at least the first time-frequency resource, the first time-frequency resource being different than the second time-frequency resource used by the second receiver to backscatter the second signal to the transmitter; the first time-frequency resource has a first frequency shifted by a first shift frequency from a frequency of the first signal; and the second time-frequency resource has a second frequency shifted by a second shift frequency from the frequency of the first signal.
Clause 33: The method of Clause 32, wherein the first shift frequency is selected from a plurality of shift frequencies associated with the first signal based on an identifier associated with the first receiver.
Clause 34: The method of Clause 33, wherein: the shift frequencies associated with the first signal comprise positive values or negative values when the first signal comprises a double band signal; or the shift frequencies associated with the first signal comprise positive values and negative values when the first signal comprises a single band signal.
Clause 35: The method of Clause 33, wherein: the shift frequencies associated with the first signal comprise values based on the frequency of the first signal.
Clause 36: The method of Clause 31, wherein: the resources specific to the first receiver comprise at least the first OCC different than the second OCC used by the second receiver to backscatter the second signal to the transmitter; and the first OCC is selected from a plurality of OCCs predefined for: at least the first receiver and the second receiver, or the first receiver only.
Clause 37: The method of Clause 36, wherein the first OCC is selected at random.
Clause 38: The method of Clause 31, wherein: the resources specific to the first receiver comprise at least the first OCC different than the second OCC used by the second receiver to backscatter the second signal to the transmitter; and the first OCC is unique to the first receiver.
Clause 39: The method of Clause 31, wherein: the first signal is assigned to a first subcarrier of a frequency division multiplexed transmission of multiple signals, including the first signal, over multiple contiguous subcarriers.
Clause 40: The method of Clause 39, wherein: the resources specific to the first receiver comprise at least the first time-frequency resource, the first time-frequency resource being different than the second time-frequency resource used by the second receiver to backscatter the second signal to the transmitter; the first time-frequency resource has a first frequency shifted from a frequency of the first signal by a first shift frequency and a frequency indicated by the first signal; and the second time-frequency resource has a second frequency shifted from the frequency of the first signal by a second shift frequency and the frequency indicated by the first signal.
Clause 41: The method of Clause 40, wherein the frequency indicated by the first signal is randomly selected from a plurality of frequencies indicated by the multiple signals.
Clause 42: The method of Clause 41, wherein each of the multiple signals, including the first signal, indicates a different value for a slot-counter parameter.
Clause 43: The method of Clause 42, wherein the second signal is received from at least the first receiver when the first receiver selects a first value for a slot-counter to be zero based on a first value for the slot-counter parameter indicated by the first signal.
Clause 44: The method of Clause 40, wherein the frequency indicated by the first signal is selected from a plurality of frequencies indicated by the multiple signals based on an identifier of the first receiver.
Clause 45: The method of any one of Clauses 30-44, further comprising: transmitting, to the first receiver, a third signal initiating a second inventory round, wherein the third signal is assigned to a first subcarrier of a frequency division multiplexed transmission of multiple signals, including the third signal, over multiple non-contiguous subcarriers; and in response to transmitting the third signal, receiving a fourth signal via a time-frequency resource specific to the first receiver, the time-frequency resource having a frequency shifted by a shift frequency from a frequency of the third signal.
Clause 46: The method of any one of Clauses 30-45, wherein receiving the second signal from at least the first receiver comprises receiving repetitions of the second signal at: different times and frequencies; or different times with a same frequency.
Clause 47: The method of Clause 46, wherein a number of the repetitions of the second signal is based on a priority associated with the first receiver.
Clause 48: The method of any one of Clauses 30-47, wherein receiving the second signal from at least the first receiver comprises receiving repetitions of the second signal via resources of a time-frequency pattern, wherein the time-frequency pattern indicates: an ID associated with the first receiver; or a portion of the ID associated with the first receiver.
Clause 49: The method of Clause 48, wherein the time-frequency pattern indicates, to the transmitter, the ID or the portion of the ID based on a priority associated with the first receiver.
Clause 50: The method of Clause 48, wherein the time-frequency pattern comprises resources from one or more resource pools based on: a number of the repetitions of the second signal; the ID associated with the first receiver; and a variable.
Clause 51: The method of Clause 48, wherein the time-frequency pattern comprises: resources at a first symbol from a first resource pool; and resources at a second symbol from a second resource pool.
Clause 52: The method of Clause 48, wherein: the resources of the time-frequency pattern have frequencies generated by applying frequency shifts to a frequency of the first signal; and the frequency shifts comprise positive values or negative values.
Clause 53: The method of any one of Clauses 30-52, wherein: an ID associated with the first receiver is divided into a plurality of segments; and receiving the second signal from at least the first receiver comprises receiving repetitions of the second signal via resources of a time-frequency pattern, wherein each of the resources of the time-frequency pattern is selected from one or more resource pools based on one of the plurality of segments.
Clause 54: The method of Clause 53, wherein a number of the repetitions of the second signal is equal to a number of the plurality of segments the ID associated with the first receiver is divided into.
Clause 55: An apparatus, comprising: a memory comprising executable instructions; and a processor configured to execute the executable instructions and cause the apparatus to perform a method in accordance with any one of Clauses 1-54.
Clause 56: An apparatus, comprising means for performing a method in accordance with any one of Clauses 1-54.
Clause 57: A non-transitory computer-readable medium comprising executable instructions that, when executed by a processor of an apparatus, cause the apparatus to perform a method in accordance with any one of Clauses 1-54.
Clause 58: A computer program product embodied on a computer-readable storage medium comprising code for performing a method in accordance with any one of Clauses 1-54.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a−b, a−c, b−c, and a−b−c, as well as any combination with multiples of the same element (e.g., a−a, a−a−a, a−a−b, a−a−c, a−b−b, a−c−c, b−b, b−b−b, b−b−c, c−c, and c−c−c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of wireless communication by a first receiver, comprising:
receiving, from a transmitter, a first signal initiating a first inventory round; and
in response to receiving the first signal, backscattering a second signal to the transmitter,
wherein the second signal is backscattered using resources specific to the first receiver.

2. The method of claim 1, wherein the resources specific to the first receiver comprise at least one of:
a first time-frequency resource, the first time-frequency resource being different than a second time-frequency resource used by a second receiver to backscatter the second signal, or
a first orthogonal cover code (OCC) different than a second OCC used by the second receiver to backscatter the second signal.

3. The method of claim 2, wherein:
the resources specific to the first receiver comprise at least the first time-frequency resource, the first time-frequency resource being different than the second time-frequency resource used by the second receiver to backscatter the second signal,
the first time-frequency resource has a first frequency shifted by a first shift frequency from a frequency of the first signal; and
the second time-frequency resource has a second frequency shifted by a second shift frequency from the frequency of the first signal.

4. The method of claim 3, further comprising:
selecting the first shift frequency from a plurality of shift frequencies associated with the first signal based on an identifier associated with the first receiver.

5. The method of claim 4, wherein:
the shift frequencies associated with the first signal comprise positive values or negative values when the first signal comprises a double band signal; or
the shift frequencies associated with the first signal comprise positive values and negative values when the first signal comprises a single band signal.

6. The method of claim 4, wherein:
the shift frequencies associated with the first signal comprise values based on the frequency of the first signal.

7. The method of claim 2, wherein:
the resources specific to the first receiver comprise at least the first OCC different than the second OCC used by the second receiver to backscatter the second signal, and
the method further comprises selecting the first OCC from a plurality of OCCs predefined for:
at least the first receiver and the second receiver, or
the first receiver only.

8. The method of claim 7, wherein the first receiver selects the first OCC at random.

9. The method of claim 2, wherein:
the resources specific to the first receiver comprise at least the first OCC different than the second OCC used by the second receiver to backscatter the second signal, and
the first OCC is unique to the first receiver.

10. The method of claim 2, wherein:
the first signal is assigned to a first subcarrier of a frequency division multiplexed transmission of multiple signals, including the first signal, over multiple contiguous subcarriers.

11. The method of claim 10, wherein:
the resources specific to the first receiver comprise at least the first time-frequency resource, the first time-frequency resource being different than the second time-frequency resource used by the second receiver to backscatter the second signal,
the first time-frequency resource has a first frequency shifted from a frequency of the first signal by a first shift frequency and a frequency indicated by the first signal; and
the second time-frequency resource has a second frequency shifted from the frequency of the first signal by a second shift frequency and the frequency indicated by the first signal.

12. The method of claim 11, further comprising:
selecting the frequency indicated by the first signal among a plurality of frequencies indicated by the multiple signals at random.

13. The method of claim 11, further comprising:
selecting the frequency indicated by the first signal among a plurality of frequencies indicated by the multiple signals based on an identifier of the first receiver.

14. The method of claim 12, wherein each of the multiple signals, including the first signal, indicates a different value for a slot-counter parameter.

15. The method of claim 14, further comprising:
selecting a first value for a slot-counter as zero based on a first value for the slot-counter parameter indicated by the first signal, wherein the first receiver backscatters the second signal to the transmitter based on the first receiver selecting the first value for the slot-counter to be zero.

16. The method of claim 15, further comprising:
determining to use the first value for the slot-counter parameter indicated by the first signal for selecting the first value for the slot-counter based on the first value for the slot-counter parameter based on a type of data to backscatter via the second signal.

17. The method of claim 15, further comprising:
determining to use the first value for the slot-counter parameter indicated by the first signal for selecting the first value at random.

18. The method of claim 15, further comprising:
determining to use the first value for the slot-counter parameter indicated by the first signal for selecting the first value for the slot-counter based on the first value for the slot-counter parameter indicated by the first signal causing the first receiver to select the first value for the slot-counter equal to zero.

19. The method of claim 14, further comping:
determining to use a first value for a slot-counter parameter indicated by the first signal for selecting a first value for a slot-counter based on the values for the slot-counter parameter indicated by the multiple signals, other than the first signal, causing the first receiver not to select a first value for the slot-counter equal to zero; and
selecting a first value for a slot-counter based on a first value for the slot-counter parameter indicated by the first signal.

20. The method of claim 1, further comprising:
receiving, from the transmitter, a third signal initiating a second inventory round, wherein the third signal is assigned to a first subcarrier of a frequency division multiplexed transmission of multiple signals, including the third signal, over multiple non-contiguous subcarriers; and
in response to receiving the third signal, backscattering a fourth signal via a time-frequency resource to the receiver, the time-frequency resource having a frequency shifted by a shift frequency from a frequency of the third signal.

21. The method of claim 1, wherein backscattering the second signal to the transmitter comprises backscattering repetitions of the second signal at:
different times and frequencies; or
different times with a same frequency.

22. The method of claim 21, wherein a number of the repetitions of the second signal is based on a priority associated with the first receiver.

23. The method of claim 1, wherein backscattering the second signal to the transmitter comprises backscattering repetitions of the second signal using resources of a time-frequency pattern, the time-frequency pattern indicates to the transmitter:
an identifier (ID) associated with the first receiver; or
a portion of the ID associated with the first receiver.

24. The method of claim 23, wherein the time-frequency pattern indicates, to the transmitter, the ID or the portion of the ID based on a priority associated with the first receiver.

25. The method of claim 23, wherein the time-frequency pattern comprises resources selected from one or more resource pools based on: a number of the repetitions of the second signal; the ID associated with the first receiver; and a variable.

26. The method of claim 23, wherein:
the resources of the time-frequency pattern have frequencies generated by applying frequency shifts to a frequency of the first signal; and
the frequency shifts comprise positive values or negative values.

27. The method of claim 1, wherein:
an ID associated with the first receiver is divided into a plurality of segments; and
backscattering the second signal to the transmitter comprises backscattering repetitions of the second signal using resources of a time-frequency pattern, wherein each of the resources of the time-frequency pattern is selected from one or more resource pools based on one of the plurality of segments.

28. A method of wireless communication by a transmitter, comprising:
transmitting, to at least a first receiver, a first signal initiating a first inventory round; and
in response to transmitting the first signal, receiving a second signal from at least the first receiver,
wherein the second signal is backscattered to the transmitter, by the first receiver, using resources specific to the first receiver.

29. A first receiver configured for wireless communications, comprising:
a memory comprising computer-executable instructions; and
a processor configured to execute the computer-executable instructions and cause the first receiver to:
receive, from a transmitter, a first signal initiating a first inventory round; and
in response to receiving the first signal, backscatter a second signal to the transmitter,
wherein the second signal is backscattered using resources specific to the first receiver.

30. A transmitter configured for wireless communications, comprising:
a memory comprising computer-executable instructions; and
a processor configured to execute the computer-executable instructions and cause the transmitter to:
transmit, to at least a first receiver, a first signal initiating a first inventory round; and
in response to transmitting the first signal, receive a second signal from at least the first receiver,
wherein the second signal is backscattered to the transmitter, by the first receiver, using resources specific to the first receiver.
